(19) United States
(12) Patent Application Publication
(10) Pub. No.: US 2014/0123051 A1
(43) Pub. Date: May 1, 2014

(54) GRAPHIC OBJECT SELECTION BY WAY OF DIRECTIONAL SWIPE GESTURES

(71) Applicant: Li Ni, New Westminster (CA)

(72) Inventor: Li Ni, New Westminster (CA)

(21) Appl. No.: 14/123,154

(22) PCT Filed: May 25, 2012
(86) PCT No.: PCT/CA2012/050346

§ 371 Date: Nov. 29, 2013

Related U.S. Application Data
(60) Provisional application No. 61/491,227, filed on May 30, 2011.

(51) Int. Cl. G06F 3/0488

(52) U.S. Cl. CPC G06F 3/04886
USPC 715/773

(57) ABSTRACT

A graphical user interface apparatus for a computing device. A method to use, arrange and activate GUI components overlapped in a graphical user interface is provided. An overlap component includes an overlappable region associated with a predetermined position locating method and a predetermined activation criterion. The overlap component may also include a conventional region. An operation located in a region and meeting the activation criterion will activate corresponding component in the GUI. A virtual keyboard comprises a plurality of keys composed of overlap components is provided. The overlap component can be invoked by a directional swipe gesture or a tap. A web browser with the use of overlap components is also provided.

### REFERENCE TO RELATED APPLICATION

This application claims priority from U.S. provisional patent application No. 61/491,227, filed 30 May 2011 and entitled GRAPHICAL USER INTERFACE. For purposes of the United States, this application claims the benefit under 35 U.S.C. §119 of U.S. provisional patent application No. 61/491,227, filed 30 May 2011 and entitled GRAPHICAL USER INTERFACE, which is hereby incorporated herein by reference for all purposes.

### TECHNICAL FIELD

This invention relates generally to graphical user interfaces (GUIs) and more specifically related to arrangement and activation of graphical user interface objects (components).

### BACKGROUND

Generally, a graphical user interface (GUI) uses graphical objects (which may also sometimes be referred to as components), such as icons, menus, buttons, images and dialog boxes with which a user may interact using a pointing device, such as a mouse, joystick, stylus, touch-pad or finger, to control a computing device.

When components in most GUI layout schemes overlap, they are typically stacked in the “z-order” which refers to the depth of components along a “z-axis” (e.g., an axis perpendicular to the surface of the screen on which the GUI is displayed). Typically, those objects at the top of the z-axis obscure the view of those objects drawn below and a hidden or overlapped component may not be easily selected or operated directly. A menu including option “send back”, “bring forward”, “send to bottom” and “bring to top” is often used to change the z-orders of overlapping components.

GUIs are used on almost all types of computer systems. Moreover, GUIs are employed in a wide range of the other products. The development of the portable electronic devices, such as mobile phones, tablet computers, handheld computers, media players, and navigation devices, has increased the need for a graphical user interface to be displayed on a small screen. A graphical user interface having an entire collection of components is often displayed at a scale in which the individual component is recognizable, but too small to easily be selected or activated. The solutions to this problem include panning, zooming, scrolling, menu, stroke-based selection, and/or combinations thereof.

A virtual keyboard which comprises a plurality of virtual keys on a touch screen may be considered a specific example of one type of graphical user interface. The use of the virtual keyboard as an input method on a portable device has increased significantly in recent years. In a limited display area, a virtual keyboard usually uses several layouts to arrange all of letters, numbers, symbols and other characters. Also, depending on the size of the screen, each of virtual keys in a keyboard layout can be very small, increasing the likelihood that a user will accidentally select neighboring keys which are close to the intended keys.

Many attempts have been made to facilitate user selection of keys on a virtual keyboard. Examples of patent literature describing technology relating to virtual keyboards and GUIs include:

US Patent Application Publication No. 2011/0109563 to Liu;

US Patent Application Publication No. 2008/0150909 to North et al.;

US Patent Application Publication No. 2010/0060597 to Choi et al.;

US Patent Application Publication No. 2011/0082620 to Small et al.;

US Patent Application Publication No. 2011/0187655 to Min et al.; and

US Patent Application Publication No. 2011/0050576 to Forutanpour.

Many solutions proposed by the prior art have limited functionality and may not be practical in certain situations. The inventor has determined a need for simple, efficient, and easy-to-learn methods and systems to arrange and activate graphical user interface objects.

### SUMMARY

Aspects of the invention provide methods and apparatus which may be used to implement novel graphical user interfaces (GUIs). Such GUIs may be used to provide user input on a wide range of computing devices. Example devices include, without limitation, smartphones and other types of phones, handheld computers, tablet computers, laptop computers, desktop computers, smart televisions and other appliances, and other types of devices or systems with real or virtual displays and internal or external processing capabilities. Certain embodiments provide methods and systems for using and arranging GUI components overlapped in a graphical user interface (referred to herein as “overlap components”) on a screen of a computing device, and methods and systems for activating the overlap components.

One aspect provides a method of converting signals from a pointing device into user inputs for controlling a computing device. The method comprises providing a graphical user interface comprising a plurality of overlap components, each overlap component having an overlappable region and an activation criterion associated therewith, each overlappable region comprising an area overlapping with an area of an overlappable region associated with at least one other overlap component, receiving and processing input signals to determine an operation location and an operation behaviour, and, activating the overlap component having an overlappable region which contains the operation location and having an activation criterion which matches the operation behavior.

In accordance with certain aspects of the invention, the GUI overlap component includes an overlappable region associated with a predetermined position locating method and a predetermined activation criterion. When a locating method detects that an operation position is located within an overlappable region of a component, and the operation behavior also meets the predetermined activation criterion of the overlappable region, the overlap component will be activated.

In accordance with a further aspect of the invention, the overlap component may also include a conventional region with a predetermined position locating method and a predetermined activation criterion. An overlap component having a conventional region is considered as a primary overlap component and an overlap component without a conventional region is considered as a secondary overlap component. When a locating method detects that an operation position is located within a conventional region of a primary overlap component, and the operation behavior also meets the predetermined activation criterion of the conventional region, the overlap component will be activated. The conventional region of a primary overlap component is non-overlapping with other conventional regions unless that these conventional regions are stacked in an order and only the conventional region on top can be activated by the conventional method. The conventional region of a primary overlap component and its corresponding activation criterion can be compatible with the activation method of a GUI component according to the prior art.

An overlappable region of a GUI overlap component provided by certain aspects of the present invention can occupy the whole of or a portion of an area or areas in common with one or more other regions of other components or any other regions of the same component if the component has more than one region (e.g., more than one overlappable region, an overlappable region and a conventional region, etc.). Each overlappable region is provided with a predetermined activation criterion which is distinct from the activation criterion of other regions with which that overlappable region overlaps. Certain overlappable regions which do not overlap may have the same activation criterion.

In accordance with a further aspect of the invention, the overlap components can be combined with certain components of a conventional GUI in a graphical user interface and will not affect the activation or operation of the components of the conventional GUI. Overlap components provided by the present invention can replace the components of conventional GUIs in various forms such as buttons, menus, text fields, sliders, images, and etc. in a GUI.

In accordance with further aspects of the invention, a pointing device such as a mouse, trackball, joystick, touch-pad, stylus, pen, finger, remote controller, or other device is used to locate an operation position on the screen. The activation criterion is predetermined and may be based on one or some of preset conditions of various inputs, status, or combinations, for example, a mouse click, a physical or virtual button action, a swipe gesture on a touch screen, voice recognition, device orientation, application state, or other inputs or conditions.

In one implementation of the present invention, there is provided a virtual keyboard on a touch screen of a computing device. The virtual keyboard comprises a plurality of virtual keys. A virtual key composed of an overlap component includes at least an overlappable region with a predetermined activation criterion. The operation location of the key is determined by the initial contact position on the touch screen. A virtual key composed of an overlap component may also include a conventional region with a conventional activation criterion. A virtual key having conventional region is considered as a primary virtual key and a virtual key without a conventional region is considered as a secondary virtual key.

In accordance with further aspects of the invention, a virtual key on a touch screen is invoked by a directional swipe or gesture with an initial operation position (e.g., initial contact point) within its overlappable region. An overlappable region of a virtual key can occupy the whole of or a portion of an area in common with some other regions of other virtual keys. A primary virtual key may also be invoked by a tap (touching down and lifting off) within its conventional region which can be compatible with the activation method of a virtual key according to the prior art. The conventional region of a primary virtual key herein is non-overlapping with the conventional regions of other primary virtual keys.

In accordance with further aspects of the invention, different keyboard layouts, including QWERTY arrangements, are adapted to the virtual keyboards comprising overlap components. Virtual keyboard layouts including more and larger area keys on a similarly dimensioned device are provided in many different ways. In some embodiments of the invention, a lowercase alphabetic virtual key can be invoked by a left-down or a right-down diagonal direction swipe with an initial contact point within its larger overlappable region while it can also be invoked by a tap on its conventional region. A number key or one of some symbol keys can be invoked by a left-up or a right-up diagonal direction swipe with an initial contact point within its overlappable region. An uppercase alphabetic virtual key can be invoked by a swipe gesture sliding to left-down then back to right-up or a swipe gesture sliding to right-down then back to left-up with an initial contact point within its overlappable region. One of a plurality of other symbols can be invoked by a swipe gesture sliding to left-up then back to right-down or a swipe gesture sliding to right-up then back to left-down with an initial contact point with its overlappable region.

In one embodiment of the invention, besides of being invoked by a tap within their conventional regions on the touch screen, a shift key is invoked by an upward swipe, backspace, enter and keyboard selector keys are each invoked by a leftward swipe, and a space key is invoked by a rightward swipe, when an initial contact point of the swipes are located within their overlappable regions. Also delete key is invoked by a leftward-then-rightward swipe gesture with an initial contact point within its overlappable region.

The virtual keys may comprise any type of characters (e.g., letters, numbers, symbols, other language characters, etc.), commands and even image icons. The regions, locating methods and activation criteria of virtual keys can be changed in different manners. Various modifications and variations of keyboard layout and keyboard display can also be adapted in other embodiments of the invention. The virtual keyboards provided by the present invention are not limited to the exact construction and operation of this summary and the illustrated examples below.

In another implementation of the invention, there is provided a web browser, which comprises overlap components, on a touch screen of a computing device. The web browser automatically replaces whole or a portion of GUI components of prior art with overlap components of present invention. The browser can keep the GUI components arrangements in a graphical user interface when it interprets the web information resource. Besides the hyperlinks displayed in the browser can still be invoked by a tap within their conventional regions, some hyperlinks can be invoked by a tap within corresponding larger overlappable regions on touch screen combined with a physical button pressed while some other hyperlinks are invoked by a tap within corresponding overlappable regions on touch screen combined with another physical button pressed.

In one implementation of the invention, components of conventional GUIs and overlap components according to certain aspects of present invention are laid out in the same graphical user interface without any affect on the activation and operation of the conventional GUI components. Also an overlap component may have more than one overlappable region and activation criterion.

It should be understood that the invention is not limited by the foregoing description, but embraces all such alterations, modifications and variations as may reasonably be inferred.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 depicts a front plan view of a user typing using an exemplary virtual keyboard on a touch screen of a computing device in accordance with an embodiment of the present invention.

FIG. 2 is an enlarged view of 4 keys from the keyboard of FIG. 1 illustrating the principles of overlap components of the present invention.

FIG. 3 depicts a user invoking key “q” using a right-down diagonal swipe initially contacted within an overlappable region on the touch screen in accordance with an embodiment of the present invention.

FIG. 4 depicts a user invoking key “w” using a left-down diagonal swipe initially contacted within an overlappable region on the touch screen in accordance with an embodiment of the present invention.

FIG. 5 depicts a user invoking key “e” using a right-down diagonal swipe initially contacted within an overlappable region on the touch screen in accordance with an embodiment of the present invention.

FIG. 6 depicts a user invoking key “w” using a tap within a conventional region on the touch screen in accordance with an embodiment of the present invention.

FIG. 7 illustrates how an activation criterion of an overlappable region of a component is distinguished from others in accordance with an embodiment of the present invention.

FIG. 8 illustrates another virtual keyboard layout with number keys and symbol keys added in accordance with an embodiment of the present invention.

FIG. 9 is an enlarged view of a portion of the keyboard of FIG. 8 illustrating additional overlappable regions for keys of the virtual keyboard of FIG. 8 in accordance with an embodiment of the present invention.

FIG. 10 depicts a user invoking various keys using different diagonal direction swipes in accordance with an embodiment of the present invention.

FIG. 11 illustrates an alternative virtual keyboard layout with further secondary virtual keys added in accordance with an embodiment of the present invention.

FIG. 12 is an enlarged view of a portion of the keyboard of FIG. 11 illustrating more overlappable regions and corresponding activation criteria of more components in an area on a touch screen in accordance with an embodiment of the present invention.

FIG. 13 depicts a user invoking key “Q” by using a swipe gesture sliding to right-down and back to left-up in accordance with an embodiment of the present invention.

FIG. 14 depicts a user invoking key “!” by using a swipe gesture sliding to right-up and back to left-down in accordance with an embodiment of the present invention.

FIG. 15 depicts a virtual keyboard with overlappable regions and corresponding activation criteria for invoking a shift key, a number/symbol selector key, a space key, an enter key, a backspace key and a delete key in accordance with an embodiment of the present invention.

FIG. 16 illustrates a view of a virtual keyboard in shift mode in accordance with an embodiment of the present invention.

FIG. 17 illustrates a view of a virtual keyboard in number and symbol mode in accordance with an embodiment of the present invention.

FIG. 18 is a flowchart illustrating a method of operating a virtual keyboard made up of a plurality of overlap components according to embodiments of the present invention.

FIG. 19 depicts a front plan view of an implementation of a web browser using overlap components on a device in accordance with an embodiment of the present invention.

FIG. 20 is an enlarged view of a portion of the device in FIG. 19 illustrating the overlappable regions and corresponding activation criteria of several components for hyperlinks in the web browser according to an embodiment of the present invention.

FIG. 21 depicts a user invoking a hyperlink using a tap on touch screen combined with a button pressed in accordance with an embodiment of the present invention.

FIG. 22 depicts a user invoking another hyperlink using a tap on touch screen combined with a different button pressed in accordance with an embodiment of the present invention.

FIG. 23 is a flowchart illustrating a method of using overlap components to implement various aspects of the present invention.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

### INTERPRETATION OF TERMS

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus or system described and illustrated. The subject matter described herein may assume various alternative orientations. Accordingly, these directional terms are not strictly defined and should not be interpreted narrowly.

The term “overlap component”, as used herein, may refer to a variety of types of selectable objects in a graphical user interface, including without limitation input characters (e.g. letters, numbers, symbols, etc.), other inputs found on keyboards (e.g., shift, tab, caps lock, control, alt, esc, command, option, backspace, delete, function keys, page up, page down, etc.), icons, navigation buttons, links, menus, images and the like. The present invention provides systems and methods for depicting and activating these components. The GUI overlap component includes an overlappable region associated with a predetermined position locating method and a predetermined activation criterion. When a locating method detects that an operation position is located within an overlappable region of a component, and the operation behavior also meets the predetermined activation criterion of the overlappable region, the corresponding overlap component will be activated.

An overlap component having a conventional region is considered as a primary overlap component and an overlap component without a conventional region is considered as a secondary overlap component. Primary overlap components may also have corresponding visual objects displayed which may be substantially coextensive with their conventional regions. The terms “key” and “virtual key” are used herein to refer to overlap components such as input characters (e.g. letters, numbers, symbols, etc.) and other inputs including, for example, those found on keyboards (e.g., shift, tab, caps lock, control, alt, esc, command, option, backspace, delete, function keys, page up, page down, etc.), whether or not such keys have corresponding visual objects displayed. A key may be regarded as a virtual mechanism to invoke a single input instead of just as a the viewable shape displayed on the screen. For example, in certain embodiments discussed below, a letter key (for example, key “w”) is considered as a overlap component while a number key (for example, key “2”) is considered as another overlap component where their overlappable regions are substantially co-extensive. Certain graphical user interface objects provided by the present invention are referred to herein as overlap components because each of these components has at least one overlappable region. An overlappable region of a component can occupy an area wholly or partially in common with other regions of other GUI components or any other regions of the same component if the component has more than one region. Corresponding to the overlappable region, a position locating method and an activation criterion are defined and used to activate the component. The overlap component provided by the present invention may also have a conventional region with its position locating method and conventional activation criterion. The use and the advantages of the overlap component will become clearer from the following description of example embodiments.

### Example Embodiments

In some embodiments, an overlappable region is provided for each of a plurality of primary overlap components each having a conventional region which may have a corresponding viewable object displayed on the screen. The conventional region may be substantially coextensive with the corresponding viewable object. In some embodiments an overlappable region is also provided for each of a plurality of secondary overlap components without a conventional region or corresponding viewable object. Each secondary overlap component may correspond to one of the primary overlap components. The overlappable regions for the secondary overlap components may be substantially co-located with overlappable regions of corresponding primary overlap components. A secondary component indication may be displayed on the viewable object of a corresponding primary overlap component to signal how to activate the secondary overlap component. In some embodiments an overlappable region is also provided for each of a plurality of modified secondary overlap components. The modified secondary overlap components may comprise modified versions of corresponding primary and/or secondary overlap components. The overlappable regions for the modified secondary overlap components may be substantially co-located with overlappable regions of corresponding primary and/or secondary overlap components. The activation criteria of the modified secondary overlap components may be selected based on the activation criteria of corresponding primary and/or secondary overlap components, and may be complementary to the activation criteria of corresponding primary and/or secondary overlap components in some embodiments.

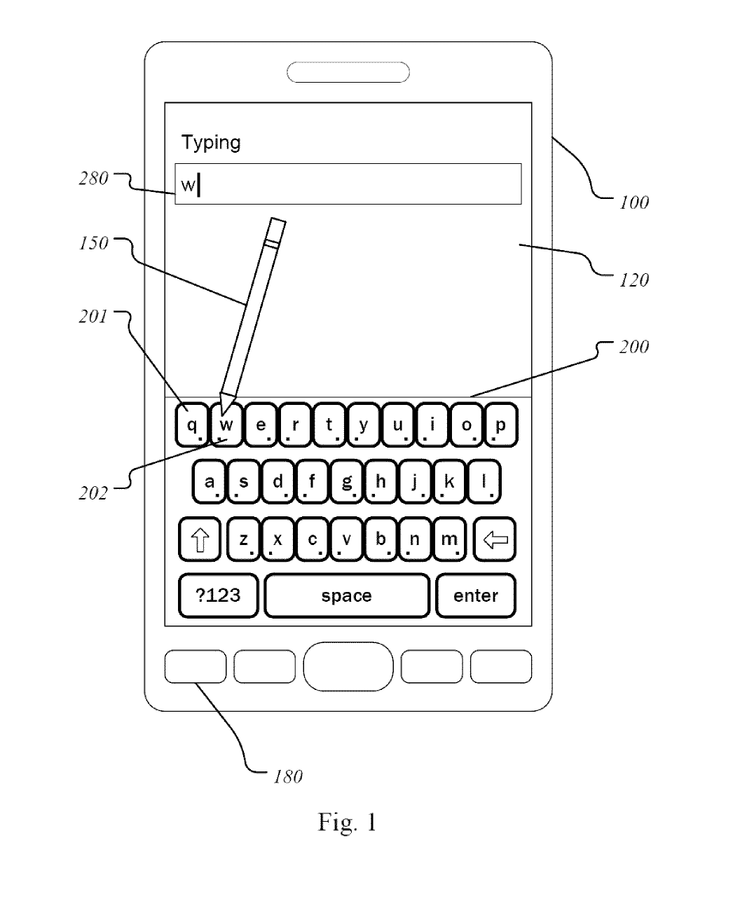

FIG. 1 illustrates a preferred embodiment according to the present invention. In one example, the overlap components are virtual keys in a virtual keyboard. Electronic device 100 may be, for example, a computer or other processor-based computing device. In this diagram, electronic device 100 is shown as a handheld device (for example, a mobile phone or a PDA) with a touch screen 120. A pointing device 150 such as a pen or stylus interacts with the screen 120. Of course, another pointing device, such as a mouse, joystick, touch-pad, or even finger, could be substituted for a pen or stylus.

Screen 120 may display a variety of program applications that require text input. For such an application, screen 120 may be divided into two (or more) areas. One area is used to show the text that the user is currently inputting in a text field 280. Another area can be used to present to the user a virtual keyboard 200 for entering the text that appears in field 280. The virtual keyboard 200 displays a plurality of virtual keys corresponding to the English alphabet and arranges the keys in rows in typical QWERTY order. On a virtual keyboard in the prior art, accurately selecting a desired key may be difficult because the virtual keys may be substantially small. In FIG. 1, The virtual keys (for example, key 201, 202) on the keyboard 200 are overlap components provided according to aspects of the present invention, which may facilitate selection of desired inputs in some embodiments as will become apparent from the following description.

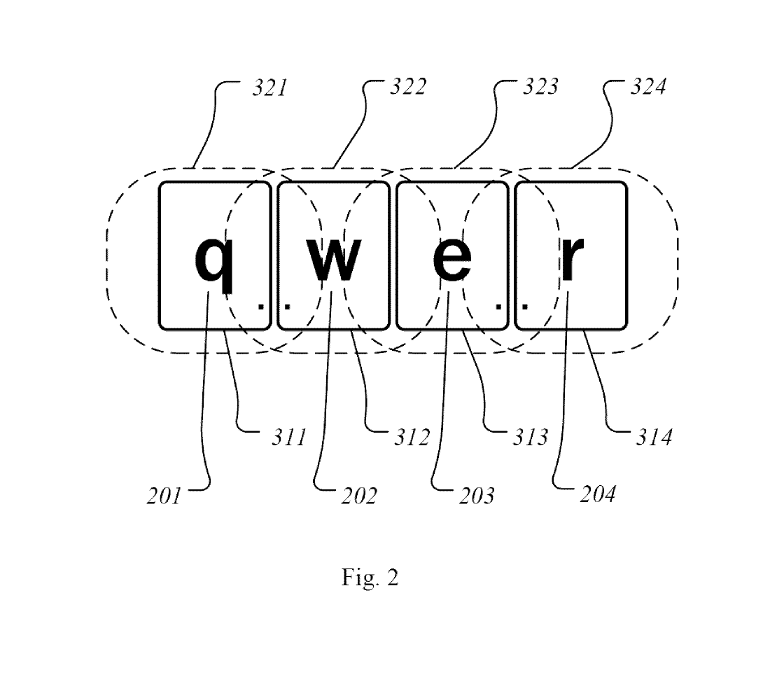

FIGS. 2 through 6 are enlarged views of a part of screen 120 in FIG. 1. FIG. 2 displays four virtual keys 201, 202, 203 and 204 for the letters “q”, “w”, “e”, and “r”, respectively, of virtual keyboard 200 in FIG. 1. In FIG. 2, each of keys 201-204 are overlap components, and have corresponding conventional regions 311-314 as described below. Regions 311-314 are depicted as rounded rectangles in the illustrated examples but could have other shapes in other embodiments. The letters “q”, “w”, “e”, and “r” may be input in a conventional manner (e.g. by tapping in the corresponding regions 311-314 as described below) in some embodiments. The letters “q”, “w”, “e”, and “r” may also be input by invoking a corresponding selectable component having an overlappable region and activation criterion associated therewith as described below.

The virtual keys 201, 202, 203 and 204 for letters “q”, “w”, “e”, and “r” have overlappable regions 321, 322, 323 and 324 respectively associated therewith. Overlappable regions 321-324 are shown in dashed lines as they are not displayed on the screen. Each overlappable region 321/322/323/324 is generally centered around the conventional region 311/312/313/314 of the associated virtual key 201/202/203/204 in the illustrated example, but this is not necessary in all embodiments. An overlappable region can occupy the whole of or a part of an area in common with other overlappable regions and/or conventional regions. For example, in FIG. 2 overlappable region 321 overlaps all of conventional region 311 and a portion of overlappable region 322 and conventional region 312, and overlappable region 323 overlaps all of conventional region 313 and portions of overlappable regions 322 and 324 and conventional regions 312 and 314. As shown in the illustrated examples, the overlappable region associated with a primary virtual key can be substantially larger than the conventional region of that key in some embodiments.

In some embodiments of the present invention, a virtual key composed of an overlap component is activated when an initial contact position of an input from a pointing device is located within the corresponding overlappable region, and the input gesture matches the predetermined activation criterion of the overlappable region. The initial input position may, for example, be a point of first contact on a touch screen. The input gesture may, for example, comprise a swipe direction generated by movement of the contact position during the input operation.

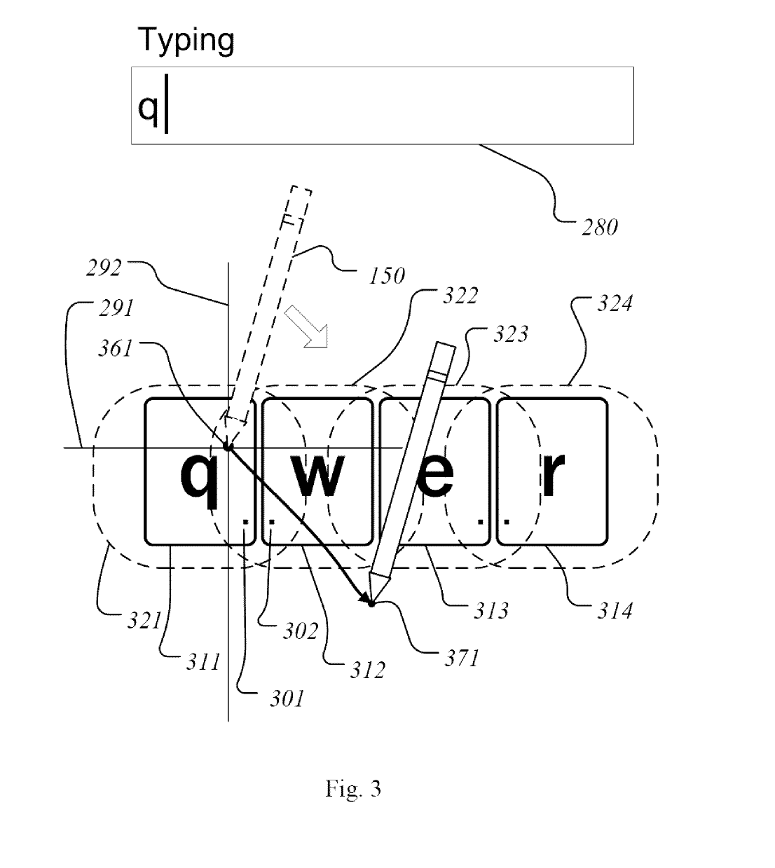

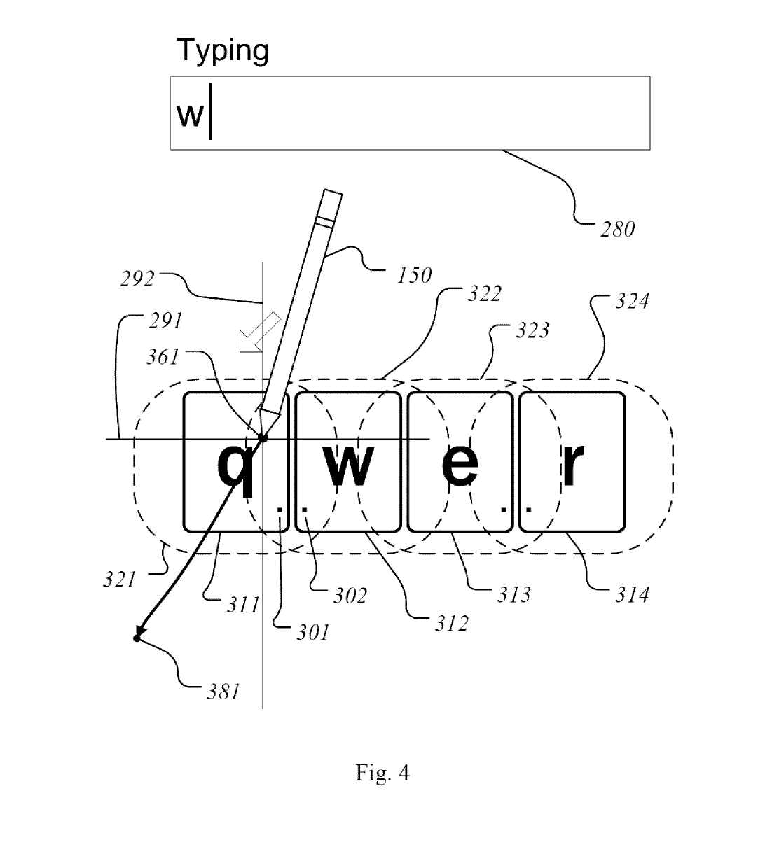

FIG. 3 illustrates a particular example of an activation process of virtual letter key “q” which is an overlap component having an overlappable region 321 with a right-down swipe as its activation criterion. A user starts a swipe with pointing device 150 (e.g., by touching down a stylus or finger on a touch screen, by pressing a mouse, joystick or other button, etc.) at a position 361 within the hidden overlappable region 321 of key “q”, and moves (e.g. by sliding the stylus or finger) in a right-down (southeast) direction, then ends the swipe (e.g. by lifting the stylus or finger from the screen) at a position 371. This operation invokes virtual letter key “q”. A character “q” is typed and displays in text field 280. Similarly, FIG. 4 illustrates a particular example of an activation process of virtual letter key “w” which is an overlap component having an overlappable region 322 with a left-down swipe as its activation criterion. In FIG. 4, a user starts a swipe with pointing device 150 at the same initial position 361, but moves in a left-down (southwest) direction, and ends the swipe at a position 381. Position 361 is also within the overlappable region 322 of key “w” which has some common area with the overlappable region 321 of key “q”. The operation shown in FIG. 4 invokes virtual letter key “w”. A character “w” is typed and displays in field 280. As illustrated in FIG. 4, the initial contact position 361 is within the overlappable region 322 of the key “w” and also the conventional region 311 of the key “q”, and is outside of the conventional region 312 of the key “w”, but the key “w” can still be invoked from position 361 by the associated activation criterion.

In some embodiments, indications may be displayed on the graphical user interface to provide the user with visual cues suggestive of the activation criteria of overlappable regions. In FIG. 3 and FIG. 4, a black dot 301 in the lower-right side of conventional region 311 of key “q” indicates that a right-down diagonal swipe is the activation criterion of the overlappable region 321 of key “q”. Also a black dot 302 in the lower-left side of conventional region 312 of key “w” indicates that a left-down diagonal swipe is the activation criterion of the overlappable region 322 of key “w”. The direction of a swipe can be determined in relation to perpendicular axes such as horizontal and vertical axes (for example, axis 291 and axis 292, which are shown for illustrative purposes but which would not generally be displayed on the screen) in correspondence to the initial contact position 361. The overlappable region 321 of key letter “q” is much bigger than the corresponding conventional region 311 of key “q” and the overlappable region 322 for the letter “w” is much bigger than the corresponding conventional region 312 of key “w”. Accordingly, some users may find it easier to point a stylus or a finger to invoke key “q” or key “w” by using overlappable region 321 or 323 in combination with the associated activation criterion. In some embodiments, the direction of an input gesture generally can be determined by the displacement of horizontal axes (DeltaX) and the displacement of vertical axes (DeltaY) of the swipe. For example:

In case both DeltaX and DeltaY are positive,

if DeltaX is more than twice of DeltaY, the swipe is considered as a right swipe;

if DeltaX is less than twice of DeltaY but more than half or DeltaY, the swipe is considered as an up-right swipe;

if DeltaX is less than half of DeltaY, the swipe is considered as an up swipe;

In case DeltaX is positive and DeltaY is negative,

if DeltaX is more than twice of DeltaY, the swipe is considered as a right swipe;

if DeltaX is less than twice of DeltaY but more than half or DeltaY, the swipe is considered as a down-right swipe;

if DeltaX is less than half of DeltaY, the swipe is considered as a down swipe;

In case DeltaX is negative and DeltaY is positive,

if DeltaX is more than twice of DeltaY, the swipe is considered as a left swipe;

if DeltaX is less than twice of DeltaY but more than half or DeltaY, the swipe is considered as an up-left swipe;

if DeltaX is less than half of DeltaY, the swipe is considered as an up swipe;

In case both DeltaX and DeltaY are negative,

if DeltaX is more than twice of DeltaY, the swipe is considered as a left swipe;

if DeltaX is less than twice of DeltaY but more than half or DeltaY, the swipe is considered as a down-left swipe;

if DeltaX is less than half of DeltaY, the swipe is considered as a down swipe.

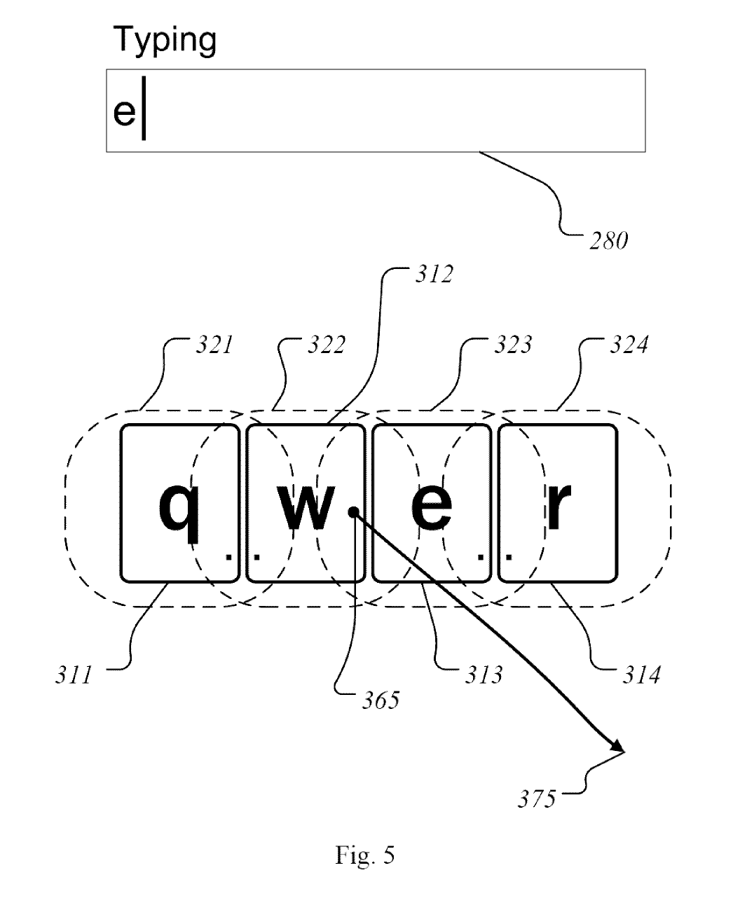

As illustrated in FIG. 5, key “e” has an associated overlappable region 323. A black dot at the lower right side of the conventional region 313 of key “e” indicates that the activation criterion of the corresponding overlappable region 323 is a right-down diagonal swipe. The user can now contact the screen with a stylus at a position within the overlappable region 323 of key “e” (for example, point 365), then slide the stylus in a right-down direction, and release from screen at a position 375 to invoke key “e”. The letter “e” is entered and character “e” will display in field 280. Position 365 is also within the overlappable region 322 of key “w”, but the activation criterion of region 322 is a left-down diagonal swipe, so key “w” will not be invoked.

The overlappable region 321 of key “q” has the same activation criterion, a right-down diagonal swipe, as the overlappable region 323 of key “e”. The overlappable region 321 of key “q” and the overlappable region 323 of key “e” do not share any common area, so a right-down diagonal swipe starting from a position within region 321 of key “q” will not activate key “e”. A right-down diagonal swipe starting from a position within region 323 of key “e” will not activate key “q” either. Similarly, the overlappable region 322 of key “w” and the overlappable region 324 of key “r” have the same activation criterion, a left-down diagonal swipe. Because region 322 and region 324 do not share any common areas, key “w” and key “r” will not be invoked at the same time by one operation.

The overlappable region 322 of key “w” overlaps both region 321 of key “q” and region 323 of key “e”, but the activation criterion (left-down diagonal swipe) of overlappable region 322 is different from the activation criterion (right-down diagonal swipe) of region 321 and region 323. An overlappable region of a component provided by the present invention can occupy the whole or a part of an area in common with more than one of other regions provided that the activation criterion of the overlappable region is different from the activation criteria of other regions with common areas. The same activation criterion can associated with more than one overlappable region when these regions are non-overlapping (e.g. do not share any common area). For example, a right-down diagonal swipe is used by both region 321 of key “q” and region 323 of key “e” in the illustrated examples. In the illustrated examples, overlappable regions 321 and 323 are separated by a gap, as are regions 322 and 324, but this is not necessary in all embodiments. For example, in some embodiments overlappable regions which have same activation criterion and are both overlapped by another overlappable region (such as region 321 of key “q” and region 323 of key “e” which are both overlapped by region 322 of key “w”) may abut one another.

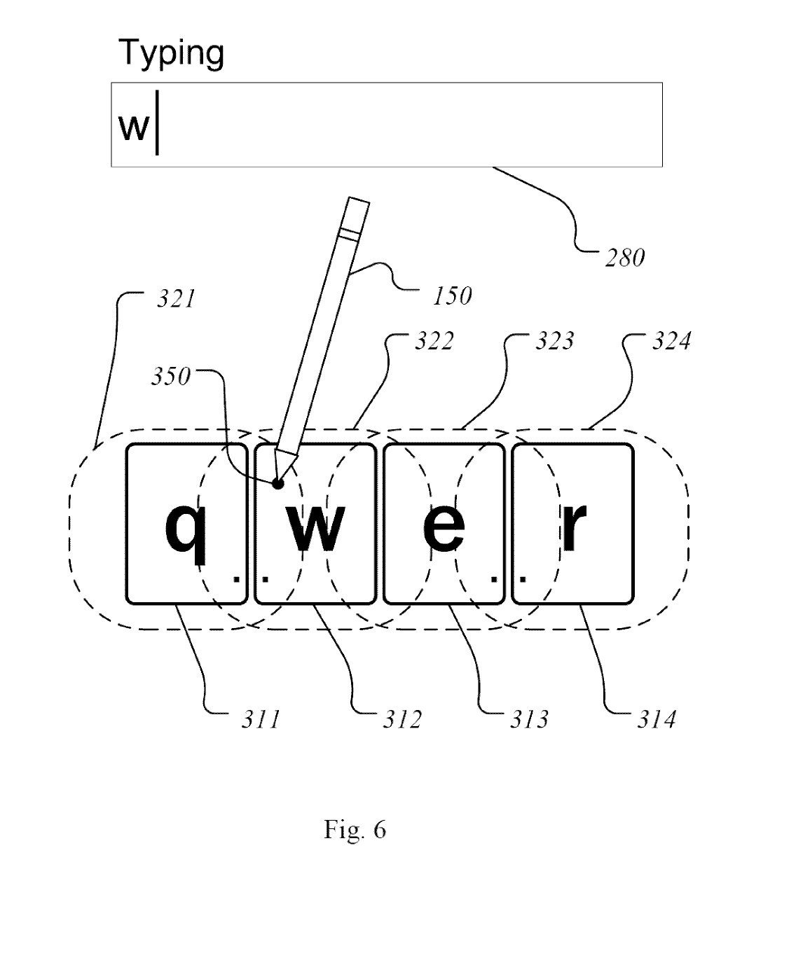

As discussed above, each primary virtual key of a graphical user interface has a conventional region for invoking the input in addition to an overlappable region. In some embodiments, the conventional region of a primary virtual key or a primary overlap component is substantially the same as the viewable shape of the key (or the component) displayed on the screen. The activation criterion of the conventional region of a primary virtual key may comprise a tap, for example. As illustrated in FIG. 6, key 201 for the letter “q” has a conventional region 311, key 202 for the letter “w” has a convention region 312, key 203 for the letter “e” has a conventional region 313, and key 204 for the letter “r” has a convention region 314. The user can now contact with pointing device 150 at a position (for example, point 350) within the conventional region 312 of key 202 for the letter “w” on the touch screen, then release without moving more than a predetermined threshold (for example, by touching a stylus or finger on the screen at point 350 then lifting the stylus or finger off the screen to input a tap gesture) to invoke key “w”. The letter “w” is entered in text field 280. The user can also invoke keys “q”, “e” or “r” by tapping at a position within conventional region 311, conventional region 313, or conventional region 314 of each primary overlap component, respectively, just same as a user invoke a virtual key according to prior art. In some embodiments, an operation behavior that meets a conventional activation criterion (e.g. a tap) will not invoke an input due to an overlappable region of any virtual key because all the activation criteria of the overlappable regions are swipe gestures. It is noted that the viewable shapes of virtual keys may not always coincide with the conventional region boundaries of the keys.

In some embodiments, primary overlap components provided by the present invention have conventional regions and the corresponding predetermined activation criteria selected to be compatible with the conventional input activation methods. In accordance with some embodiments, the conventional regions of soft keys on a virtual keyboard are separated, and the activation criterion of a conventional region of a key is different from the activation criterion of an overlappable region of the key. For example, in some embodiments of the virtual keyboard 200 shown in FIG. 1, a user can still enter an input associated with any virtual key by tapping on the displayed key shape area on the touch screen.

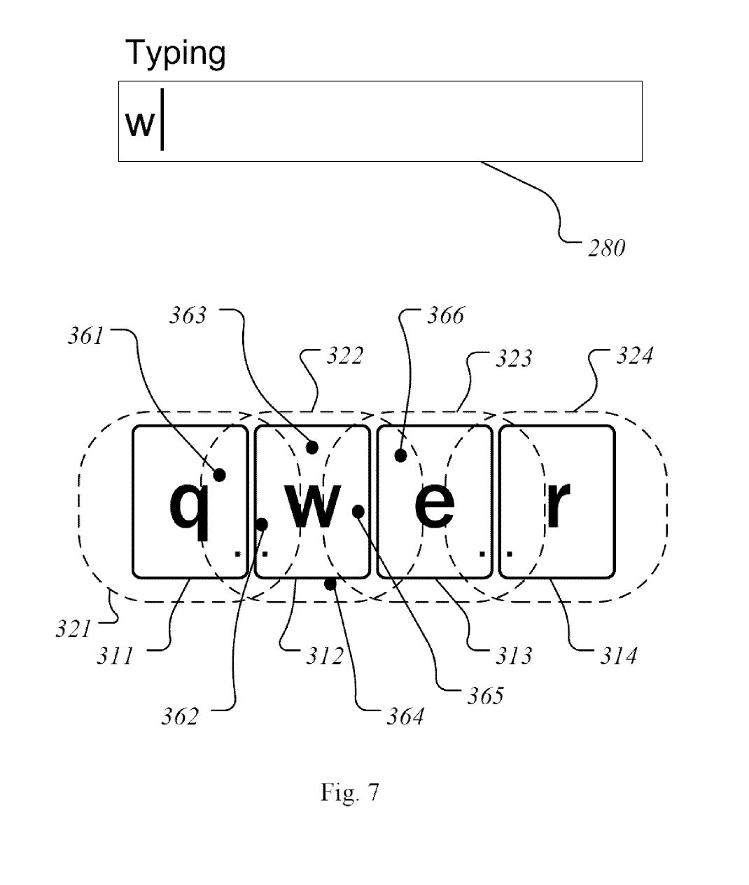

FIG. 7 illustrates examples of how a virtual key may be activated on a virtual keyboard in accordance with some embodiments from a variety of initial position. In the illustrated example, all these positions (for example, 361, 362, 363, 364, 365, and 366) are located within the overlappable region 322 of key “w”. When a user touches down the pointing device at one of these positions, follows by a left-down direction slide, and lifts the pointing device from the screen, the letter “w” will be invoked. The position of the initial contact within region 322 is not important so long as the input gesture matches the activation criterion of a left-down swipe. The activation process will become clearer from the following description.

In addition to being within region 322 of key “w”, position 361 is also located within the conventional region 311 of the key “q” whose activation criterion is a tap, and within the overlappable region 321 of the key “q” whose activation criterion is a right-down swipe. Position 362 is also located within the overlappable region 321 of the key “q” whose activation criterion is a right-down swipe. Position 363 is also located within the conventional region 312 of the key “w” whose activation criterion is a tap. Position 364 is not within any other regions. Position 365 is also located within the overlappable region 323 of the key “e” whose activation criterion is a right-down swipe. Position 366 is also located within the conventional region 313 of the key “e” whose activation criterion is a tap, and within the overlappable region 323 of the key “e” whose activation criterion is a right-down swipe. A left-down slide which starts from any position within the overlappable region 322 of the key “w” will not meet the activation criteria of the listed regions that the position is located in, so any other inputs will not be invoked. If the user input a right-down swipe from position 363 or position 364, because position 363 and position 364 are not located in any overlappable region whose activation criterion is a right-down swipe, no key will be activated.

According to some preferred implementations of the present invention described above, key “w” can be invoked by either matching an activation criterion of the associated conventional region or matching an activation criterion of the associated overlappable region. In some embodiments, every letter key of the virtual keyboard with a QWERTY arrangement shown in FIG. 1 comprises an overlap component according to aspects of the present invention, such that every other letter key may be similarly invoked by either matching an activation criterion of the associated conventional region or matching an activation criterion of the associated overlappable region. In some embodiments, every letter key has a hidden overlappable region whose activation criterion is a right-down diagonal swipe if a black dot is marked on the lower-right side of the viewable object of the associated key or whose activation criterion is a left-down diagonal swipe if a black dot is marked on the lower-left side of the viewable object of the associated key. In some embodiments, the initial contact position of an operation is used for locating the input operation. The available initial contact area for invoking a key can be much bigger when using the overlappable region and the corresponding activation criterion than the contact area when using only the conventional region and conventional activation criterion.

In some embodiments, by using overlap components provided according to aspects of the present invention, the amount of the objects laid out in a graphical user interface can be increased. This feature may be better understood by reference to the detailed description of specific embodiments of following virtual keyboard examples.

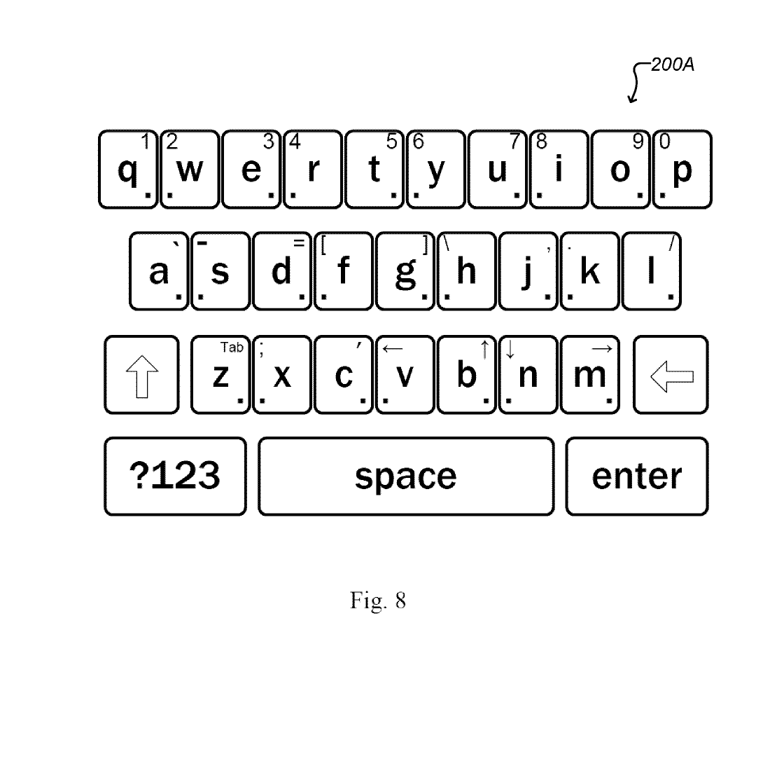

FIG. 8 illustrates an example layout for a virtual keyboard 200A according to one embodiment. In addition to a black dot displayed at the lower-left or lower-right corner of each letter key (which is the same as the layout in FIG. 1 and will not be described again), a digit, punctuation, or other symbol is displayed at upper-left or upper-right side of the letter key. The virtual keyboard 200A shown in FIG. 8 may be used to invoke alphabetic inputs, number inputs, punctuation inputs, and special symbol inputs by providing overlap components for such inputs, as described below.

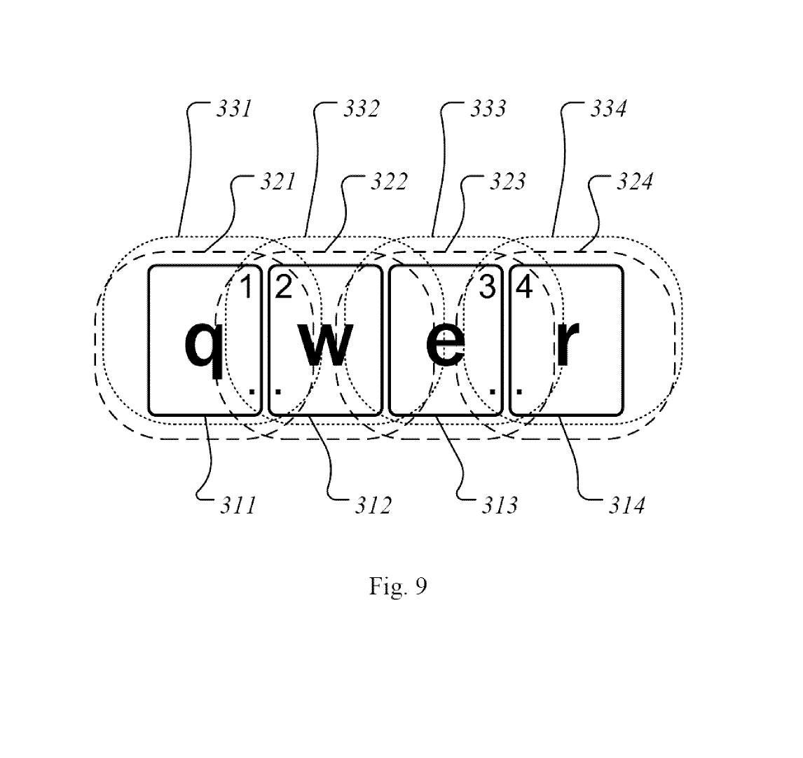

FIG. 9 is an enlarged view of a portion of virtual keyboard 200A shown in FIG. 8. In FIG. 9, secondary virtual keys for number symbols “1”, “2”, “3” and “4” are added and labeled at upper-left or upper-right side of the viewable shapes of the primary virtual keys for the letters “q”, “w”, “e” and “r”.

The overlap component for the number “1” does not have an associated conventional region, so the key “1” cannot be invoked just by a conventional tap. The secondary virtual key “1” has an overlappable region 331. A label at the upper-right side of the key for the letter “q” is used to indicate that the activation criterion of the overlappable region 331 of the key “1” is a right-up diagonal swipe. Likewise, the overlap components for the numbers “2”, “3” and “4” do not have associated conventional regions, so these number keys also cannot be invoked just by a conventional tap. Instead, keys “2”, “3” and “4” have an overlappable regions 332, 333, and 334, respectively. Labels at the upper-left sides of the keys for the letters “w” and “r” are used to indicate that the activation criteria of the overlappable region 332 of key “2” and overlappable region 334 of key “4” is a left-up diagonal swipe, and a label at the upper-right side of the key for the letter “e” is used to indicate that the activation criterion of the overlappable region 333 of key “3” is a right-up diagonal swipe. Overlappable regions 331-334 of number keys are depicted as slightly offset from the overlappable regions 321-324 of the letter keys, but this is not required. In some embodiments overlappable regions 331-334 may be substantially co-extensive with overlappable regions 321-324, respectively.

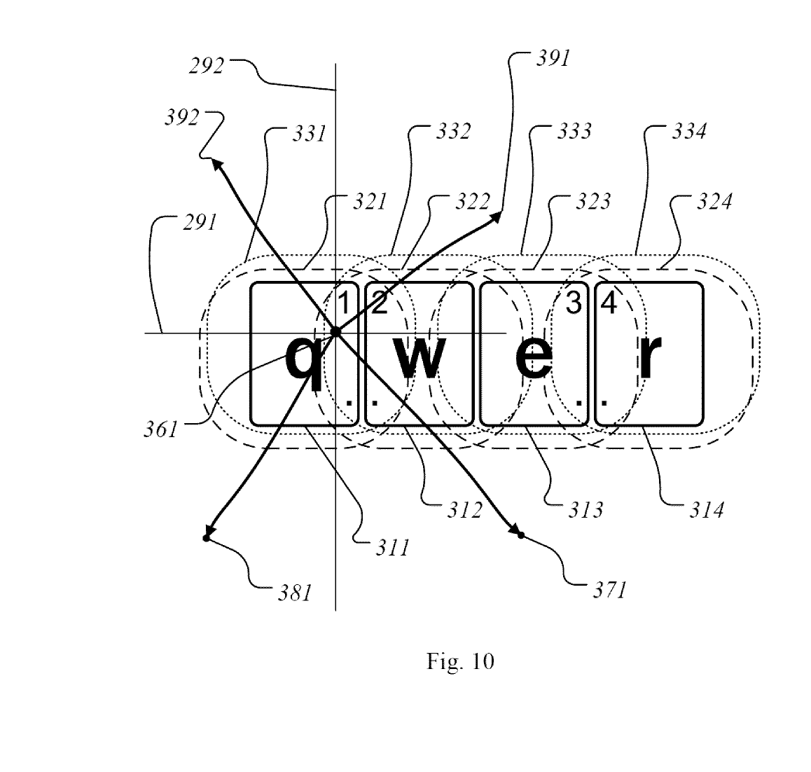

Referring to FIG. 10, additional overlap components for invoking numeric inputs are added on the limited area of the screen, but the activation methods which are used to invoke the alphabetic keys are not affected because the new overlappable regions of the numeric keys have different activation criteria which can be distinguished from old ones. For example, in the FIG. 10 example, position 361 is now located within 5 regions, including conventional region 311 of key “q”, overlappable region 321 of key “q”, overlappable region 322 of key “w”, overlappable region 331 of key “1”, and overlappable region 332 of key “2”. A tap at position 361 only matches the activation criterion of conventional region 311 of key “q”, and will invoke the letter “q”. A right-down diagonal swipe from position 361 to position 371 only matches the activation criterion of overlappable region 321 of key “q”, and will also invoke the letter “q”. A left-down diagonal swipe from position 361 to 381 only matches the activation criterion of overlappable region 322 of key “w”, and will invoke the letter “w”. A right-up diagonal swipe from position 361 to position 391 only matches the activation criterion of overlappable region 331 of key “1”, and will invoke the number “1”. A left-up diagonal swipe from position 361 to 392 only matches the activation criterion of overlappable region 332 of key “2”, and will invoke the number “2”.

Referring back to FIG. 8, all the alphabetic keys with a black dot at the lower-left side of its viewable shape area can be invoked by either a conventional tap or a left-down swipe on corresponding regions. All the alphabetic keys with a black dot at the lower-right side of its viewable shape area can be invoked by either a conventional tap or a right-down swipe on corresponding regions. A number or symbol key having an indication labeled at the upper-left side of an alphabetic key can be invoked by a left-up swipe on a corresponding region. A number or symbol having an indication labeled at the upper-right side of an alphabetic key can be invoked by a right-up swipe on a corresponding region.

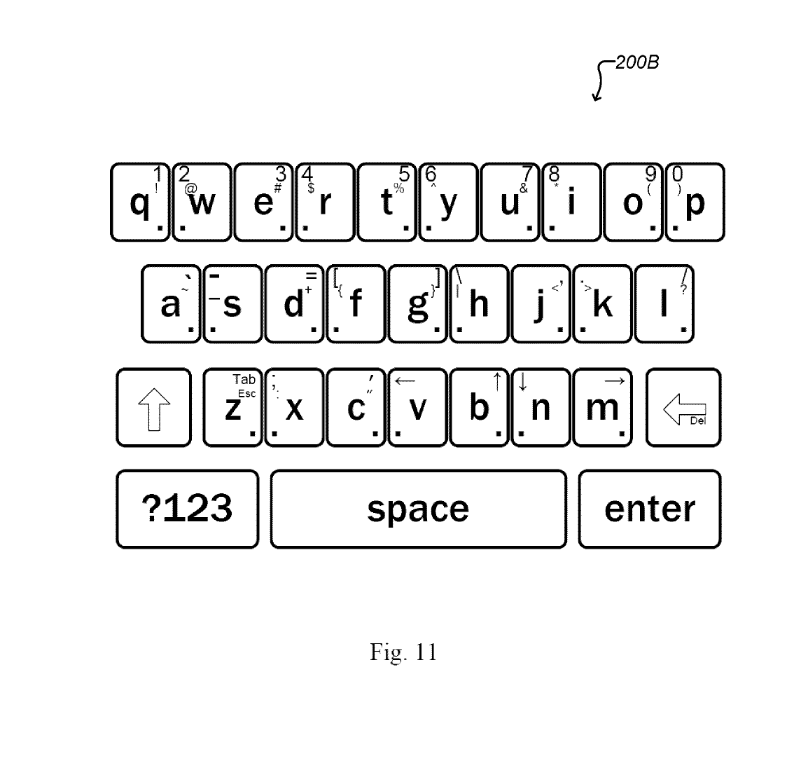

FIG. 11 illustrates an example layout for a virtual keyboard 200B according to one embodiment. The QWERTY virtual keyboard 200B of the FIG. 11 example includes almost all keys which would be available in a standard full keyboard configured for input in the English language. The main difference between the virtual keyboard 200B of FIG. 11 and the virtual keyboard 200A of FIG. 8 is that more special symbols (for example, “!”, “@”, and etc.) and uppercase letter keys are added as overlap components according to aspects of the present invention, as described below.

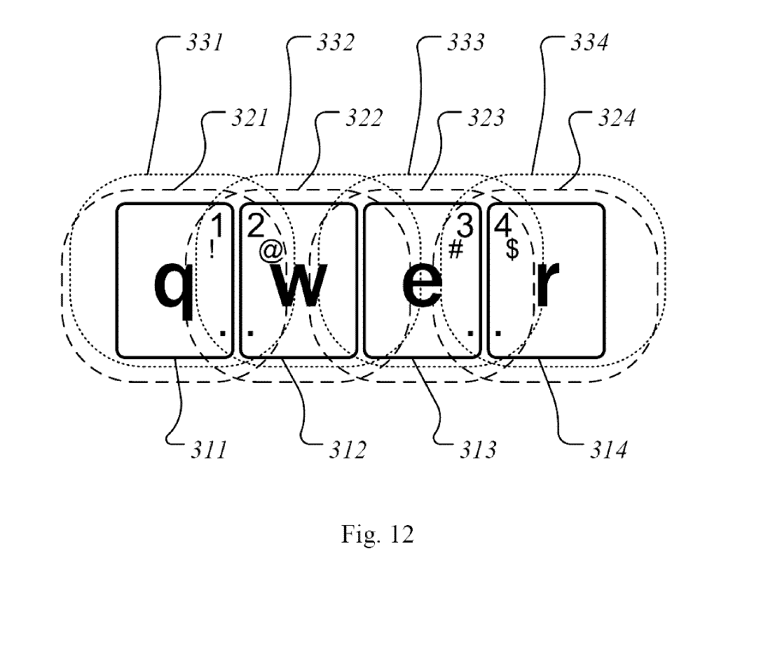

FIG. 12 illustrates a portion of the virtual keyboard shown in FIG. 11. As shown in FIG. 12, in addition to primary virtual keys “q”, “w”, “e”, “r” with the associated black dots and indications for secondary virtual keys “1”, “2”, “3”, “4”, indications for symbol keys “!”, “@”, “#”, “$” are displayed on the screen. Also secondary virtual keys for the uppercase letter keys “Q”, “W”, “E”, “R” are provided. Indications for the uppercase letter keys “Q”, “W”, “E” and “R” are not directly displayed or labeled on the screen, but these uppercase letter keys can be invoked as described below.

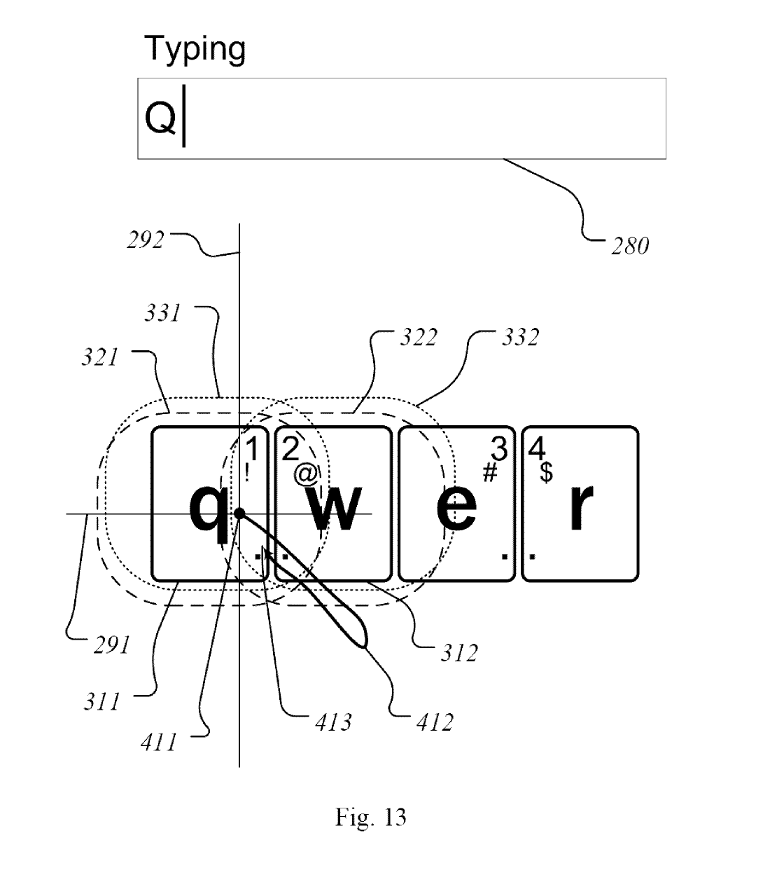

Referring to FIG. 13, the secondary overlap component for uppercase letter “Q” does not have a conventional region and cannot be invoked by a conventional tap. The secondary virtual key “Q” has an overlappable region 321 which is the same as the overlappable region of the key “q”. The activation criterion of the overlappable region 321 of the key “Q” is a swipe gesture sliding to right-down then back to left-up (as opposed to just a right-down swipe of the coextensive overlappable region of the key “q”). Similarly, the secondary overlap component for key “W” does not have a conventional region and cannot be invoked just by a conventional tap. Key “W” has an overlappable region 322 which is the same as the overlappable region of the key “w”. The activation criterion of the overlappable region 322 of the key “W” is a swipe gesture sliding to left-down then back to right-up.

In FIG. 13, the user touches down a stylus at position 411 within the overlappable region 321 of the key “Q”, follows by a sliding motion in a right-down direction, then turns back at position 412 toward the reverse direction (up-left direction), and lifts the stylus from the screen at position 413. This action invokes uppercase letter “Q”, and a character “Q” is typed and displays in text field 280. A swipe gesture sliding to right-down then back to left-up is the activation criterion of the overlappable region 321 of the key “Q”. The uppercase letter “Q” is not directly displayed on the virtual keyboard, but the initial contact area and the activation method of key “Q” is implied by the key “q”. The initial contact position 411 of the swipe gesture is located within several regions of different keys, but only one activation criterion of an overlappable region matches the operation behavior so that only one key can be invoked.

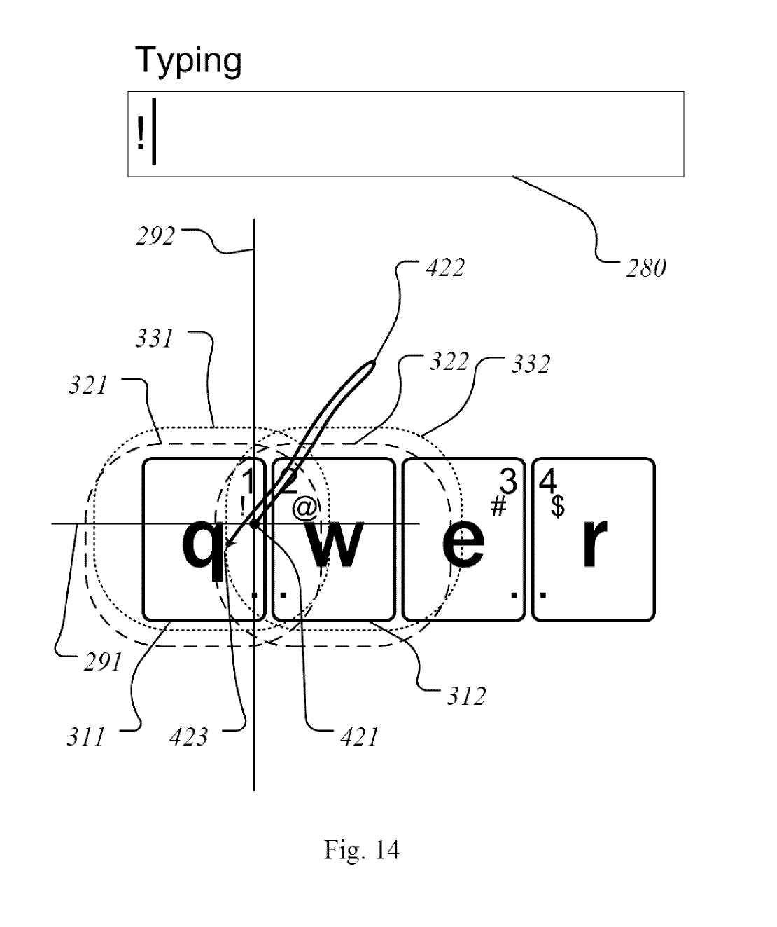

Referring to FIG. 14, the secondary overlap component for the symbol key “!” does not have a conventional region and cannot be invoked by a conventional tap. The secondary virtual key for symbol “!” has an overlappable region 331 which is the same as the overlappable region of the key “1”. The activation criterion of the overlappable region 331 of the key “!” is a swipe gesture sliding to right-up then back to left-down (as opposed to just a right-up swipe of the coextensive overlappable region of the key for the number “1”). Similarly, the secondary overlap component for the symbol “@” does not have a conventional region and cannot be invoked by a conventional tap. The key “@” has an overlappable region 332 which is the same as the overlappable region of the key “2”. The activation criterion of the overlappable region 332 of the key “@” is a swipe gesture sliding to left-up then back to right-down.

In FIG. 14, the user touches down a stylus at position 421 within the overlappable region 331 of the key “!”, follows by a right-up direction sliding motion, then turns back at position 422 toward reverse direction (down-left direction), and lifts the stylus from the screen at position 423. This action invokes the symbol “!”, and a character “!” is typed and displays in text field 280. A right-up slide and reverse swipe gesture is the activation criterion of the overlappable region 331 of key “!”. The initial contact position 421 of the swipe gesture is located within several regions of various keys, including conventional region 311 of the key “q” (the activation criterion of which is a tap), overlappable region 321 of the key “q” (the activation criterion of which is a right-down swipe), overlappable region 322 of the key “w” (the activation criterion of which is a left-down swipe), overlappable region 321 of the key “Q” (the activation criterion of which is a swipe gesture sliding to right-down then back to left-up), overlappable region 322 of the key “W” (the activation criterion of which is a swipe gesture sliding to left-down then back to right-up), overlappable region 331 of the key “1” (the activation criterion of which is a right-up swipe), overlappable region 332 of the key “2” (the activation criterion of which is a left-up swipe), overlappable region 331 of the key “!” (the activation criterion of which is a swipe gesture sliding to right-up then back to left-down), and overlappable region 332 of the key “@” (the activation criterion of which is a swipe gesture sliding to left-up then back to right-down). The operation shown in FIG. 14 only matches the activation criterion of overlappable region 331 of the key “!”, so only the symbol “!” is invoked.

Referring back to FIG. 12, the key “E” may be invoked similarly to the key “Q” and the “R” may be invoked similarly to the key “W”. The overlap component for the letter “E” does not have a conventional region and cannot be invoked just by a conventional tap. The key “E” has an overlappable region 323 whose activation criterion is a swipe gesture sliding to right-down then back to left-up. The overlap component for the letter “R” does not have a conventional region and cannot be invoked just by a conventional tap. The key “R” has an overlappable region 324 whose activation criterion is a swipe gesture sliding to left-down then back to right-up. An activation criterion of an overlappable region can be adapted by another overlappable region if both regions are non-overlapping.

Referring still to FIG. 12, the key “#” may be invoked similarly to the key “!” and the key “$” may be invoked similarly to the key “@”. The overlap component for the symbol “#” does not have a conventional region and cannot be invoked just by a conventional tap. The key “#” has an overlappable region 333 whose activation criterion is a swipe gesture sliding to right-up then back to left-down. The overlap component for the symbol “$” does not have a conventional region and cannot be invoked just by a conventional tap. The key “$” has an overlappable region 334 whose activation criterion is a swipe gesture sliding to left-up then back to right-down.

With the aid of the viewable shapes, label positions or other visual indications displayed on the virtual keys, a user can operate the QWERTY keyboard conveniently and effectively without much memorization. The virtual keyboard 200C displayed in FIG. 11 may be used to invoke almost all standard English language inputs available on a standard keyboard, including lowercase and uppercase alphabetic keys, number keys, punctuation keys, and special symbols keys. These virtual keys are all overlap components similar to keys “q”, “Q”, “1”, “!” described above. The lowercase alphabetic keys can be invoked by a conventional tap or a left-down or right-down diagonal swipe. Uppercase alphabetic keys can be invoked by a forward and reverse swipe gesture sliding to left-down then back to right-up or sliding to right-down then back to left-up. The digit number keys and some symbol keys can be invoked by a left-up or right-up diagonal swipe, and some symbol keys can be invoked by a forward and reverse swipe gesture sliding to left-up then back to right-down or sliding to right-up then back left-down to according to label positions. The exemplary keyboard shown in FIG. 11 reduces the frequency of the switch among alternative keyboard layouts.

As noted above, some overlap components may not be graphically displayed. Also an overlappable region of a component may have the same area as a region of others. An overlappable region can be inside of a region of others as well. These characteristics of an overlap component provided by aspects of the present invention can facilitate high-density layout of GUI objects.

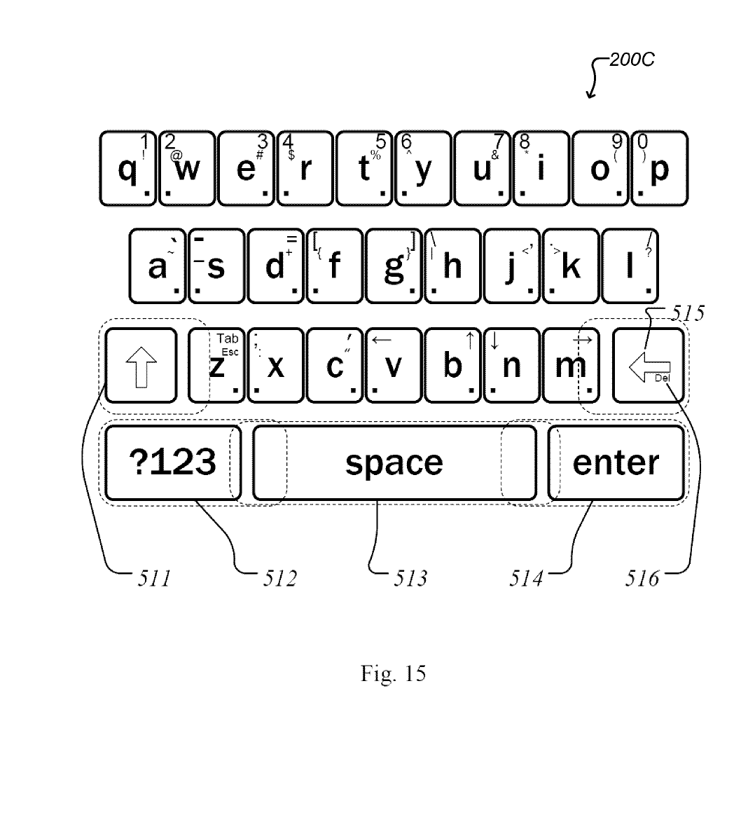

The activation criteria of the overlappable regions of some keys in the virtual keyboard can use other direction swipe gestures to intuitively match these keys instead of the example diagonal direction swipe gestures discussed in the examples above. FIG. 15 illustrates an example layout for a virtual keyboard 200C according to one embodiment, which is similar to keyboard 200B of FIG. 11. As shown in FIG. 15, virtual shift key 511, alternative number/symbol keyboard selector key 512, space key 513, enter key 514, and backspace key 515 are also overlap components. Each of these primary virtual keys has both a conventional region and an overlappable region which can be bigger than its viewable area. User can invoke these keys by tapping on their conventional regions or swiping from their overlappable regions. The activation criterion of the overlappable region of shift key 511 is an upward swipe. The activation criterion of the overlappable region of alternative keyboard selector key 512 is a leftward swipe. The activation criterion of the overlappable region of space key 513 is rightward swipe. The activation criterion of the overlappable region of enter key 514 is a leftward swipe. The activation criterion of the overlappable region of backspace key 515 is also a leftward swipe. Virtual delete key 516 is an secondary overlap component which does not have a conventional region, but may have a visual indication displayed on backspace key 515. Delete key 516 can be invoked by a leftward-then-rightward swipe gesture.

Alternative virtual keyboard layouts are also supported by embodiments of the present invention. In case continuous uppercase letters input or continuous numbers or symbols input is needed, a user can switch the current keyboard layout in FIG. 15 to other keyboard layouts by invoking shift key 511 or alternative keyboard selector key 512.

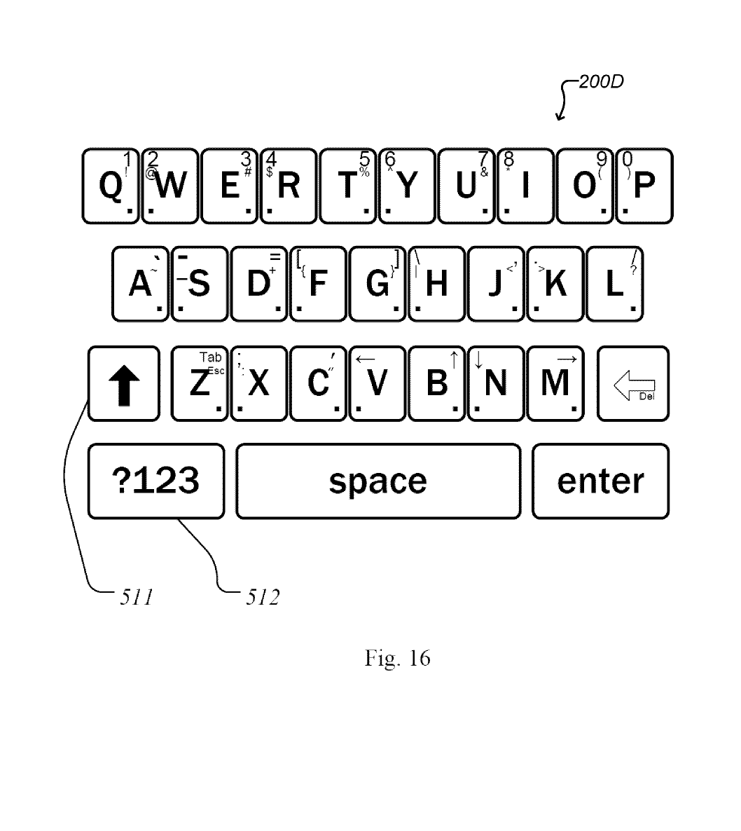

FIG. 16 illustrates an alternative exemplary keyboard layout of a virtual keyboard 200D where uppercase alphabetic keys become primary keys. A tap on a conventional region will invoke an uppercase letter key instead of a lowercase letter key. The uppercase letter keys can be also invoked by a left-down swipe or a right-down swipe initially on the corresponding overlappable region. To invoke a lowercase letter key from keyboard 200D, the user touches down a stylus or figure within the overlappable region, then slides to left-down direction then back to right-up direction, or slides to right-down direction then back to up-left direction, and releases. Using the activation method of overlap components provided by aspects of the present invention, the user can still enter various digit number keys and symbol keys on the virtual keyboard shown in FIG. 16.

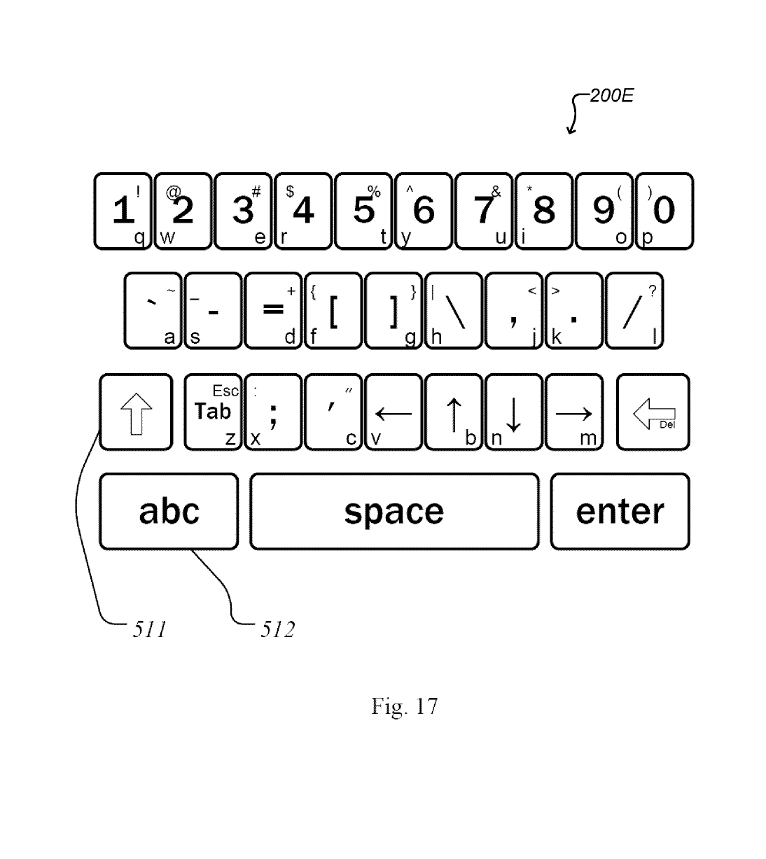

FIG. 17 illustrates another exemplary keyboard layout of a virtual keyboard 200E after the user invoked alternative keyboard selector key 512. As shown in FIG. 17, digit number keys and some symbol keys become primary keys and can be invoked by a conventional tap. These keys can also be invoked by a left-up swipe or a right-up swipe initially on the corresponding overlappable region. The lowercase letter keys can only be invoked from keyboard 200E by a left-down swipe or a right-down swipe on the corresponding overlappable region. The uppercase letter keys and some other symbol keys in FIG. 17 can still be invoked by various swipe gestures as same as the activation methods described above with respect to FIG. 15.

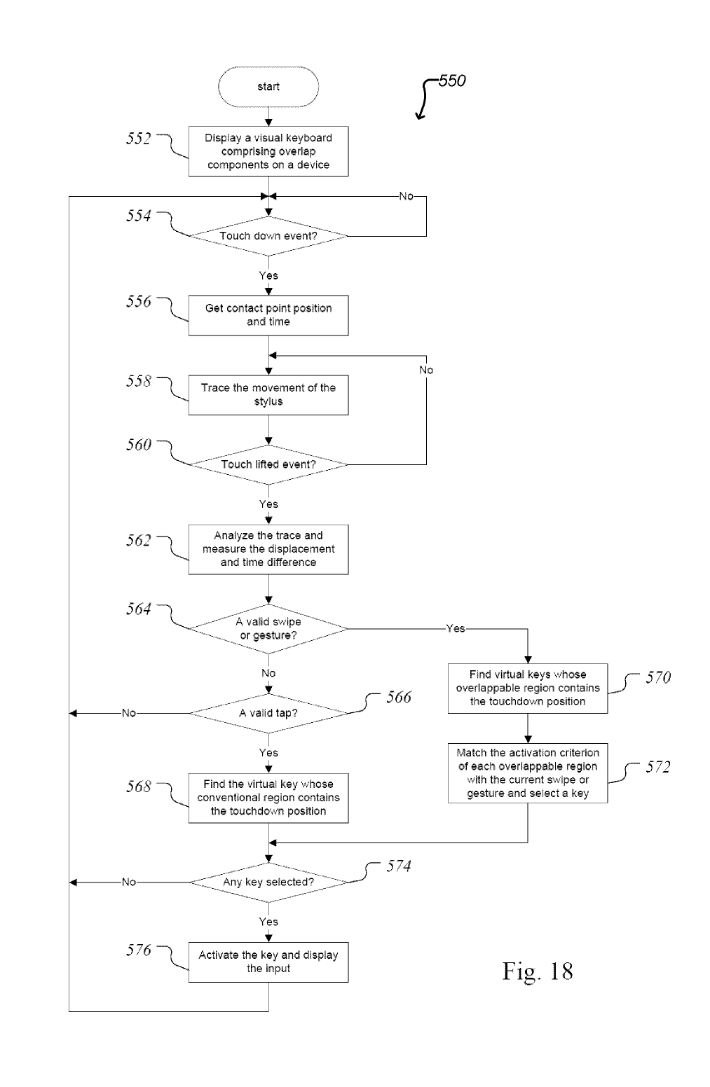

FIG. 18 shows a flow chart of an example method 550 of the operation process of an exemplary virtual keyboard made up of a plurality of overlap components according to a preferred embodiment. In step 552, a virtual keyboard comprising a plurality overlap components is displayed on the screen of a device. The device can be one of a mobile phone, a handheld computer, a PDA, as well as a desktop computer, a portable computer, a tablet computer, a media player, a game console, or other computing device. The display can take the form of a touch-sensitive screen, but can also be a CRT, LCD or other monitor. The touch screen or other screen is controlled by a stylus, a pen, a finger or other pointing device, such as a mouse, a joystick, a touch-pad or a remote controller.

The device waits at step 554 until a touch-down event, after which processing proceeds to step 556. In step 556, device gets the initial contact position on the screen and records the touch time. From step 558 to step 560, the stylus movement path is traced. In step 560, the device checks whether the stylus has been moved off the touch screen. If there is no liftoff event (step 560 No branch), method 550 repeats steps 558 and 560.

After a liftoff event, the device analyzes the received trace data in step 562 and determines whether the operation is a valid swipe (step 564) or tap (step 566) gesture depending on whether the stylus displacement and time difference exceed predetermined thresholds in step 564 and step 566. For example, in some embodiments, if the displacement of a movement on the display is less a threshold (e.g. 1 cm), or if the time difference between the initial contact and the end of contact is more than a threshold (e.g. 10 seconds), the movement will not be considered as a valid swipe or gesture. If the operation is not a valid swipe or gesture (step 564 No branch) and not a valid tap (step 566 No branch), method 550 returns to step 554 to await another touch-down event.

If the operation is a valid swipe or gesture (step 564 Yes branch) and not a valid tap (step 566 No branch), method 550 proceeds to steps 570 and 572. In step 570 and step 572, the device finds out the virtual key depending on whether the initial contact position is located within the overlappable region of the virtual key and whether the action and direction of the current swipe or gesture matches the activation criterion of the overlappable region. If the operation is not a valid swipe or gesture (step 564 No branch) and is a valid tap (step 566 Yes branch), method 550 proceeds to step 568. In step 568, when a conventional tap is detected, the device selects the virtual key whose conventional region the contact position is located within.

In step 574 and step 576, the device invokes the virtual key, implements the function of the activated key, and updates the GUI display.

The virtual keyboard provided by the present invention should not be limited to the exact construction and operation as illustrated and described above. The virtual keys may comprise any type of characters (e.g., letters, numbers, symbols, other language characters, etc.), commands and even image icons. The regions, locating methods and activation criteria of virtual keys can also be changed in different ways. Various modifications and variations of keyboard layout and keyboard display can be adapted without departing from scope of the invention.

The general concepts discussed above with the specific examples of virtual keys of virtual keyboards are generally applicable to other GUI objects and other computer applications.

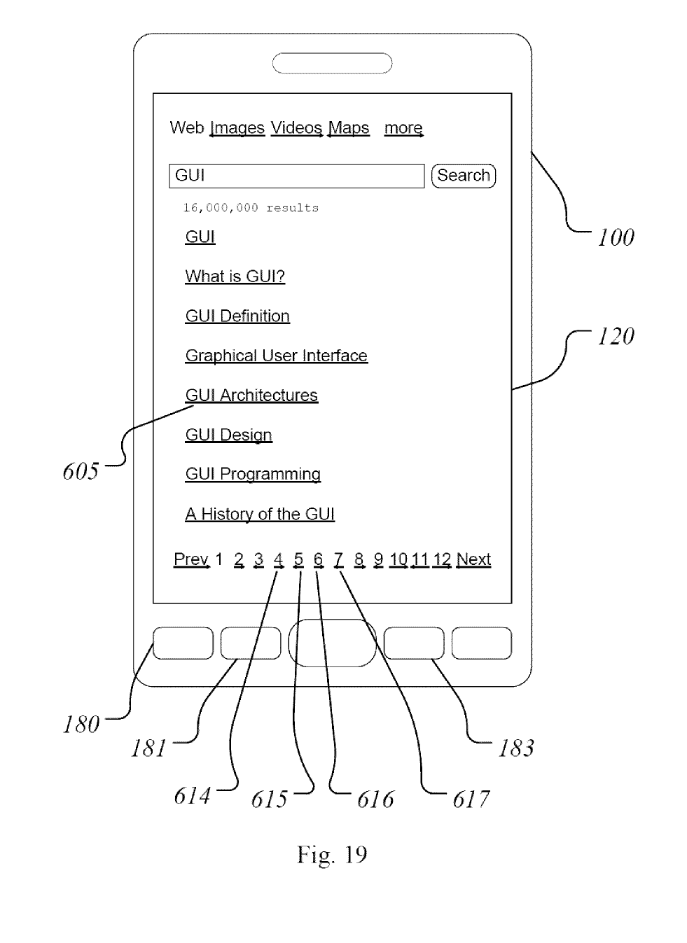

FIG. 19 illustrates a web browser used on a mobile device 100 with a touch screen 120 in accordance with an embodiment of the present invention. The mobile device 100 also includes several physical buttons (e.g. 180, 181, 183, etc.) under the touch screen 120. A user may use a finger or a stylus directly on the touch screen 120 to operate the GUI.

In the web browser, an example of web search results page is displayed. The web search results may include a list of many hyperlinks and have to be arranged in sequenced web pages. A user can activate a hyperlink of listed search result (for example, link 605) to redirect to a target web page, or activate a hyperlink of a sequenced page number (for example, link 614, link 615) to display other results on the screen.

Because of space limitations of the mobile device, web page contexts and links in the exemplary browser may be displayed substantially small so that they may be recognizable to a user, but may not be easily accessible by a user. Using overlap components according to aspects of the present invention in a web browser may facilitate activation of small links and other objects. In FIG. 19, a browser provided by an embodiment of the present invention automatically replaces some traditional hyperlink GUI objects which are close to other GUI objects (e.g., separated by less than a predetermined distance) with the overlap components which are marked with arrows underneath the links when the browser retrieves, parses and displays the information resources.

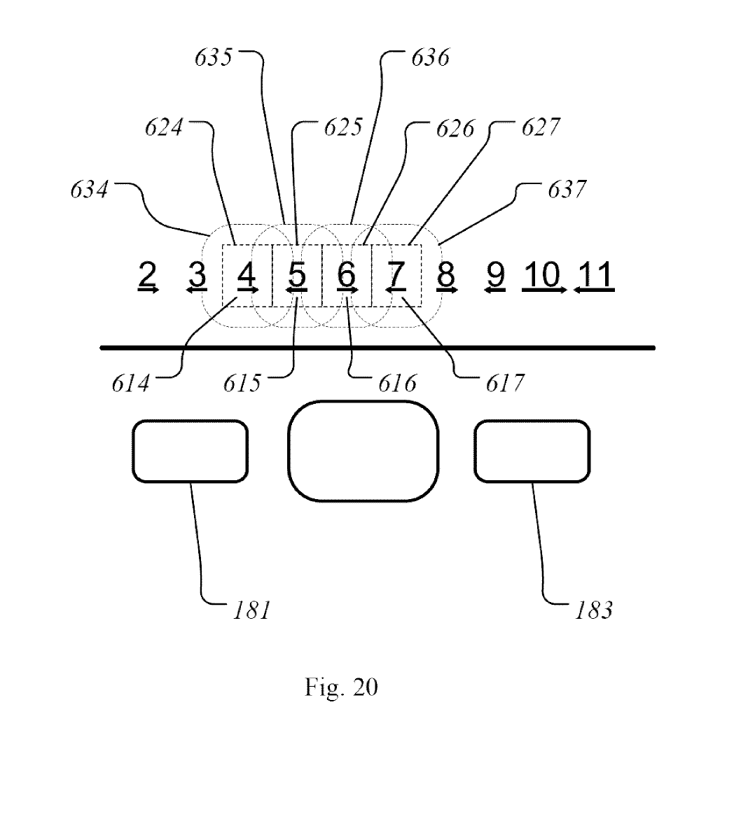

FIG. 20 is an enlarged view of a part of device 100 in FIG. 19. The GUI component linking to the page numbers are automatically configured by the browser as overlap components which have both conventional regions and overlappable regions. Some of these overlap components are indicated by an underline with a leftward arrow. The others are indicated by an underline with a rightward arrow. The leftward and rightward arrows may be arranged in alternating fashion.

Referring to some example hyperlinks shown in FIG. 20, link 614 to search result page 4 has a conventional region 624 and an overlappable region 634. Link 615 to page 5 has a conventional region 625 and an overlappable region 635. Link 616 to page 6 has a conventional region 626 and an overlappable region 636. Link 617 to page 7 has a conventional region 627 and an overlappable region 637. It should be noted that these conventional regions and overlappable regions may not be directly displayed on the screen. Each conventional region of a page link is non-overlapping with another conventional region. An overlappable region of a page link is bigger than its associated conventional region and has partial common area with the overlappable regions of the adjacent page hyperlinks.

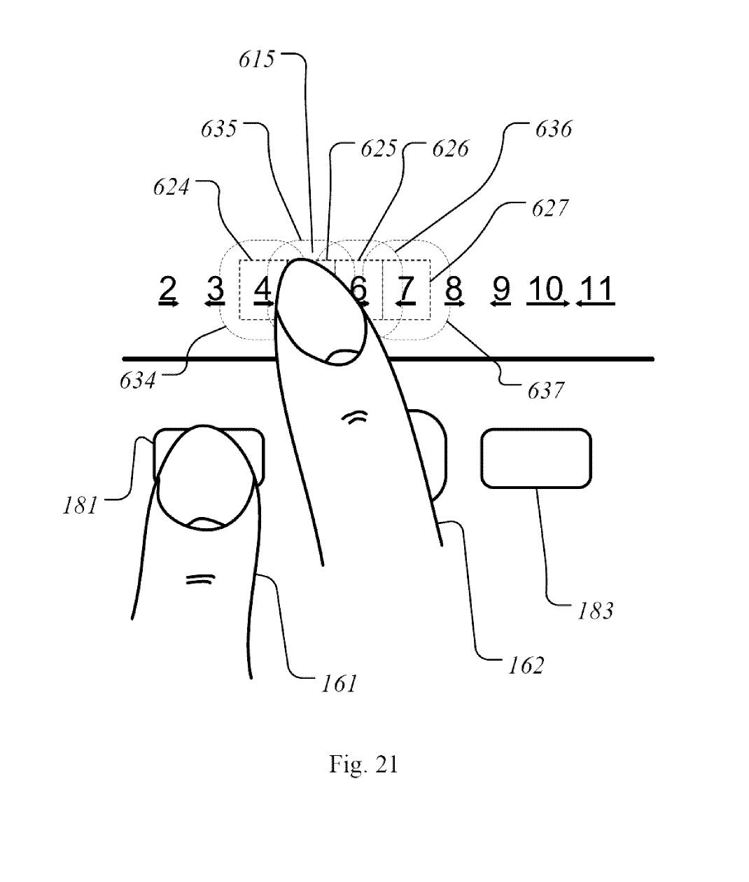

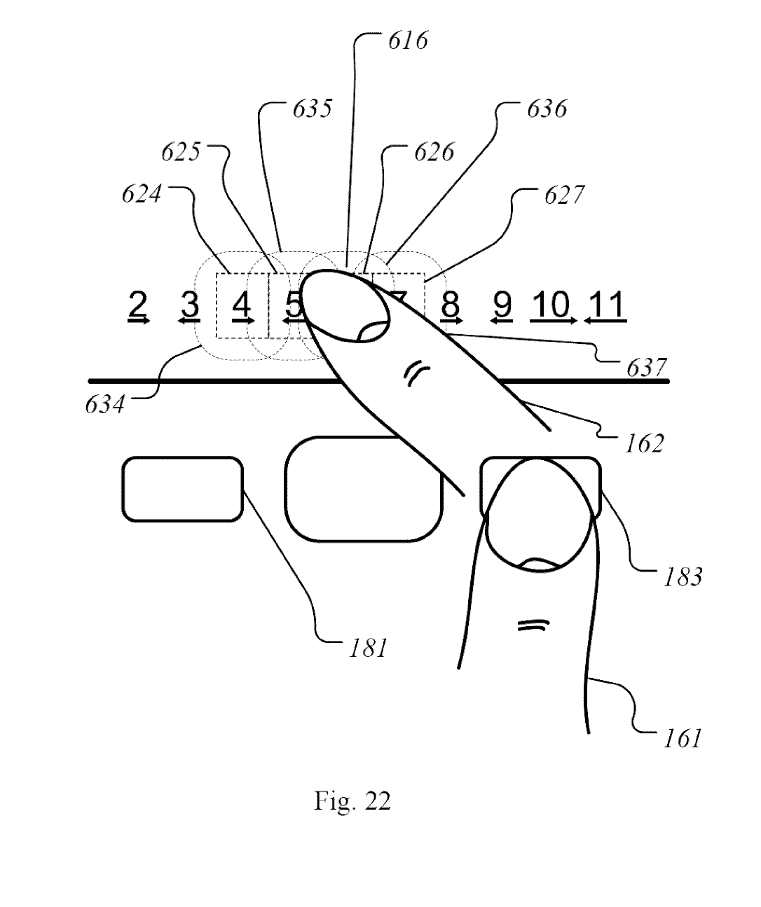

Referring to FIG. 21, when a user presses and holds down button 181 of the mobile device by a finger 161, then touches down and release his another finger 162 at a position within overlappable region 635 on the screen, the link 615 is activated and the web page displayed in the browser will be redirected to search results page 5. A tap on touch screen combined with button 181 pressed is the activation criterion of overlappable region 635 of link 615. Referring to FIG. 22, when a user presses and holds down button 183 by a finger 161, then touches down and release another finger 162 at a position within overlappable region 636 on the screen, the link 616 is activated and the web page displayed in the browser will be redirected to search results page 6. A tap combined with button 183 pressed is the activation criterion of overlappable region 636 of link 616.

Referring back to FIG. 20, link 615 is underlined with a leftward arrow. The overlappable regions of those hyperlinks which are underlined with a leftward arrow (for example, region 637 of link 617) have the same activation criterion (a tap combined with button 181 pressed) as region 635 of link 615. Link 616 is underlined with a rightward arrow. The overlappable regions of those hyperlinks which are underlined with a rightward arrow (for example, region 634 of link 614) have the same activation criterion (a tap combined with button 183 pressed) as region 636 of link 616.

The user can also activate a hyperlink by a tap on the corresponding conventional region on touch screen (for example, region 625 and region 626) without any button pressed. The conventional activation criterion of a conventional region will not affect any overlappable region.

Region 635 of link 615 overlaps partial area of overlappable region 634 of link 614 and overlappable region 636 of link 616, as well as whole or a portion of area of conventional region 624, 625 and 626. The activation criterion of region 635 (a tap combined with button 181 pressed) can only activate link 615 because it does not match the activation criterion of region 634 and 636 (a tap combined with button 183 pressed), and is also different from the activation criterion of region 624, 625 region 626 (a tap without a button pressed). The overlappable region 635 of link 615 is much bigger than the conventional region 625 so it is possible that a user do not have to zoom into the area on the screen to operate the function.

Referring to FIG. 19, some hyperlinks (for example, link 605) are underlined without any arrows. These hyperlinks are still components of the prior art and can just be activated by a simple tap on the touch screen. It should be appreciated that components of the prior art can be mixed with overlap components provided by aspects of the present invention in a graphical user interface. Conventional regions are not allowed to overlap each other unless they are stacked in an order in some embodiments and only the conventional region on top can be activated if the activation criterion is matched in some embodiments.

The examples described above have focused primarily on that each overlap component has one overlappable region with one activation criterion. However, an overlap component provided by the present invention may have multiple overlappable regions with multiple corresponding activation criteria. For example, a hyperlink underlined with a leftward arrow like link 615 can be configured to be activated not only by a tap combined with button 181 pressed on an overlappable region, but also by a leftward swipe on another similar overlappable region on the screen. A hyperlink underlined with a rightward arrow like link 616 can be configured to be activated not only by a tap combined with button 183 pressed on an overlappable region, but also by a rightward swipe on another similar overlappable region.

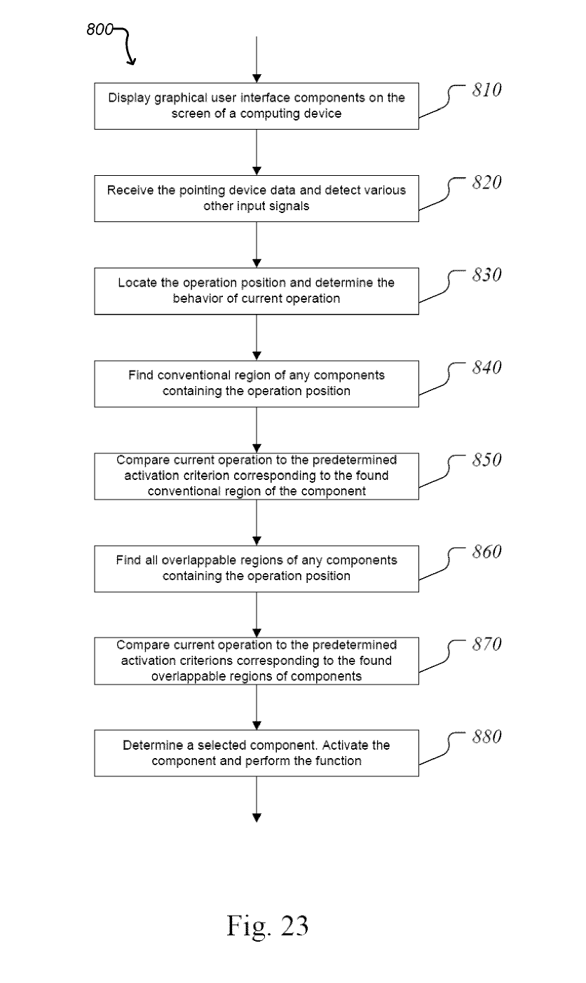

FIG. 23 depicts a flow diagram illustrating an example method 800 of the process of using overlap components to implement various aspects of the present invention.

In step 810, a plurality of graphical user interface components are displayed on the screen of a computing device. The computing device can comprise a variety of different types, such as desktop computers, portable computers, tablet computers, handheld computers, PDAs, media players, game consoles, mobile phones, telephones, navigation devices, consumer electronics, or other devices embedding a processor or combination of devices. The components on the screen are graphical user interface objects including components according to the prior art and overlap components according to the present invention. The overlap components of the present invention can replace most of the prior art components such as button, checkbox, menu, slider, text field, image, and etc.

From step 820 to step 830, the device keeps receiving the pointing device input data and other input signals to determine the location and the behavior of the operation action. The pointing device includes a mouse, trackball, joystick, touch-pad, stylus, pen, finger, remote controller, or other devices. The location of current action can be determined by different ways. For example, it can be the position where a mouse is pressed or released, or where a finger touches down or lifts off on the touch screen, or can also be a calculated value according to the travel path of a pointing device in a period of time. The device also keeps detecting other input signals. Various signals may also be configured as a part of the operation, for example, physical or virtual button status, device orientation, voice recognition, application state, and etc.

In step 840, the process determines whether the operation position is located within a conventional region of a component. The component is either a GUI object of the prior art or an overlap component of present invention. A GUI object of the prior art can be considered as a particular overlap component which exists a conventional region with a corresponding activation criterion and does not have any overlappable regions. In step 850, the process compares the current operation behavior to the predetermined activation criterion corresponding to the found conventional region.

In step 860, the process finds out all the overlappable regions of any components containing the operation location. In step 870, the process compares the current operation behavior to the predetermined activation criteria corresponding to the found overlappable regions of components.

In step 880, the process determines a selected component according to the comparison result in step 850 and step 870. The selected component will be activated and the function will be performed.

Although example embodiments of the present invention have been described herein with the reference to the accompanying drawings, it is to be understood that the invention is not limited to those exact constructions and operations, and that various other changes and modifications may be made by one skilled in the art without departing from the scope or spirit of the invention.

Embodiments of the invention may be implemented using specifically designed hardware, configurable hardware, programmable data processors configured by the provision of software (which may optionally comprise ‘firmware’) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”) and the like. Examples of configurable hardware are: one or more programmable logic devices such as programmable array logic (“PALs”), programmable logic arrays (“PLAs”) and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A method of converting signals from a pointing device into user inputs for controlling a computing device, the method comprising:
providing a graphical user interface comprising a plurality of primary overlap components, each primary overlap component having a conventional region and a conventional activation criterion associated therewith and an overlappable region and an overlappable activation criterion associated therewith, wherein the conventional activation criterion of the conventional region for each primary overlap component is different from the overlappable activation criterion of the overlappable region for the primary overlap component, each overlappable region comprising a common area overlapping with an overlappable region associated with at least one other primary overlap component, and wherein the overlappable activation criteria associated with the primary overlap components with the overlappable regions containing the common area are different and the conventional activation criteria associated with the primary overlap components with the overlappable regions containing the common area are identical;
receiving and processing input signals to determine an operation location and an operation behaviour;
activating a primary overlap component having a conventional region which contains the operation location when the operation behavior matches the conventional activation criterion of the primary overlap component; and,
activating a primary overlap component having an overlappable region which contains the operation location when the operation behavior matches the overlappable activation criterion of the primary overlap component.

2. A method according to claim 1 wherein processing the input signals to determine the operation location comprises determining an initial operation position.

3. A method according to claim 1 wherein processing the input signals to determine the operation behaviour comprises determining an input gesture.

4. A method according to claim 1 wherein the conventional region of each primary overlap component comprises an area on a display which is non-overlapping with any other conventional regions of other primary overlap components.

5. A method according to claim 4 wherein a corresponding visual object is displayed for each conventional region.

6. A method according to claim 5 wherein the conventional region is substantially coextensive with the corresponding visual object.

7. A method according to claim 1 wherein the identical conventional activation criteria of each of the primary overlap components with overlappable regions having overlapping areas is a tap, and wherein the primary overlap components with overlappable regions having overlapping areas are virtual keys.

8. A method according to claim 1 wherein the graphical user interface comprises a plurality of secondary overlap components.

9. A method according to claim 8 wherein each secondary overlap component corresponds to one of the primary overlap components, and the overlappable region of each secondary overlap components is substantially co-located with the overlappable region of the corresponding primary overlap component.

10. A method according to claim 9 comprising displaying a secondary input indication on the visual object of a primary overlap component to signal how to activate the corresponding secondary overlap component.

11. A method according to claim 9 wherein the secondary overlap components do not have viewable objects displayed corresponding to the overlappable regions of the secondary overlap components.

12. A method according to claim 8 wherein the plurality of overlap components comprise a plurality of modified overlap components, each modified overlap component comprising a modified version of a corresponding primary or secondary overlap component.

13. A method according to claim 12 wherein the overlappable regions for each modified overlap component is substantially co-located with the overlappable regions for the corresponding primary or secondary overlap component.

14. A method according to claim 12 wherein activation criteria of the modified overlap components are complementary to activation criteria of corresponding primary or secondary overlap components.

15. A method according to claim 8 wherein activation criteria of the secondary overlap components are complementary to activation criteria of corresponding primary overlap components.

16. A method according to claim 1 wherein a plurality of points on a display screen are common to a plurality of overlappable regions, comprising providing overlappable regions having any points on the display screen in common with each other with mutually distinct activation criteria.

17. A method according to claim 8 wherein the overlappable region of one overlap component overlaps portions of two other overlappable regions of two other overlap components, wherein the two other overlappable regions have identical activation criteria and are non-overlapping with each other.

18. A method according to of claim 1 wherein receiving and processing input signals comprises one of:
receiving and processing an input signal from a pointing device;
receiving and processing a combination of input signals from a pointing device and a physical button; and,
receiving and processing a combination of input signals from pointing devices and a physical button.

19. A method according to claim 1 wherein receiving and processing input signals to determine the operation location comprises one of:
determining a contact position of a tap or a click of a pointing device;
determining an initial contact position of a directional swipe of a pointing device;
determining an initial contact position of a gesture of a pointing device;
determining an end position of a gesture of a pointing device; and,
determining a calculated position value according to the travel path of a pointing device in a period of time.

20. A method according to claim 8 wherein the associated activation criterion of an overlappable region of an overlap component comprises one of:
a directional swipe of a pointing device;
a gesture of a pointing device; and,
a tap of a pointing device combined with a pressing of a physical button.

21. A method according to claim 1 wherein the associated activation criterion of each conventional region comprises a tap or a click of a pointing device.

22. A method according to claim 1 comprising:
providing at least two groups of overlap components, wherein each of the two groups has at least two components, each component of the first group has an overlappable region having an identical first activation criterion, each component of the second group has an overlappable region having an identical second activation criterion, and the first activation criterion is distinct from the second activation criterion, wherein the overlappable region of a first group component does not overlap with the overlappable region of any other first group component, and the overlappable region of a second group component does not overlap with the overlappable region of any other second group component, wherein the overlappable region of at least one first group component overlaps the overlappable regions of at least two components of the second group, and the overlappable region of at least one second group component overlaps the overlappable regions of at least two components of the first group;
activating the first group overlap component having an overlappable region which contains the operation location if the operation behavior matches the first activation criterion; and,
activating the second group overlap component having an overlappable region which contains the operation location if the operation behavior matches the second activation criterion

23. A method comprising:
providing a virtual keyboard comprising a plurality of virtual keys arranged in a plurality of rows, wherein the plurality of virtual keys comprise a plurality of primary overlap components each having a conventional region and a conventional activation criterion associated therewith, and at least one overlappable region and an overlappable activation criterion associated therewith, wherein the conventional activation criterion of the conventional region for each primary overlap component is different from the overlappable activation criterion of the overlappable region for the primary overlap component, each overlappable region the primary overlap component comprising a common area overlapping with an overlappable region associated with at least one other primary overlap component, and wherein the overlappable activation criteria associated with the primary overlap components with the overlappable regions containing the common area are different and the conventional activation criteria associated with the primary overlap components with the overlappable regions containing the common area are identical;
receiving and processing input signals to determine the operation location according to a position location method and determine the operation behavior, wherein the input signal comprises an input signal from a pointing device;
activating a primary overlap component of a primary virtual key having a conventional region which contains the operation location and having the associated conventional activation criterion which matches the operation behavior; and,
activating a primary overlap component of a virtual key having an overlappable region which contains the operation location and having the associated overlappable activation criterion which matches the operation behavior.

24. A method according to claim 23 further comprising providing a primary overlap component of a virtual key having a conventional region which is non-overlapping with the conventional region of any other primary overlap component of each virtual key wherein the identical activation criterion associated with the conventional region comprises a tap.

25. A method according to claim 23 further comprising providing a primary overlap component of a virtual key having an overlappable region which overlaps at least one overlappable region of a neighboring primary overlap component of a virtual key in the same row.

26. A method according to claim 25 wherein at least four adjacent primary overlap components of virtual keys in the same row each has an overlappable region with one of two activation criteria, wherein the two activation criteria are assigned to the primary overlap components of the virtual keys in alternating fashion.

27. A method according to claim 26 wherein the two activation criteria associated with the overlappable regions of the primary overlap components of the virtual keys in the row comprise a down-right swipe and a down-left swipe.

28. A method according to claim 23 wherein the activation criteria associated with the overlappable regions of the virtual keys comprise one of:
a directional swipe; and,
a directional forward and reverse gesture.

29. A method according to claim 46 comprising providing a virtual keyboard comprising one or more of:
a plurality of primary overlap components comprising lowercase letter keys;
a plurality of secondary overlap components comprising number keys;
a plurality of secondary overlap components comprising punctuation keys;
a plurality of secondary overlap components comprising symbol keys; and,
a plurality of secondary overlap components comprising uppercase letter keys.

30. A method according to claim 29 wherein a plurality of primary overlap components of virtual keys are switchable to secondary overlap components of virtual keys wherein a plurality of secondary overlap components of virtual keys are switchable to primary overlap components of virtual keys.

31. A method according to claim 29 wherein the virtual keyboard comprises one or more of;
a primary overlap component for inputting a shift comprising a conventional region with an activation criterion of a tap, and an overlappable region with an activation criterion of an upward swipe;
a primary overlap component for an alternative selector comprising a conventional region with an activation criterion of a tap, and an overlappable region with an activation criterion of a leftward swipe;
a primary overlap component for inputting a space comprising a conventional region with an activation criterion of a tap, and an overlappable region with an activation criterion of a rightward swipe;
a primary overlap component for inputting an enter comprising a conventional region with an activation criterion of a tap, and an overlappable region with an activation criterion of a leftward swipe;
a primary overlap component for inputting a backspace comprising a conventional region with an activation criterion of a tap, and an overlappable region with an activation criterion of a leftward swipe; and,
a secondary overlap component for inputting a delete comprising an overlappable region with an activation criterion of a leftward-then-rightward gesture, the overlappable region substantially coextensive with the overlappable region of the backspace key.

32. A method according to claim 1 wherein the graphical user interface comprises a virtual keyboard wherein the primary overlap components comprise a plurality of virtual keys arranged in a plurality of rows.

33. A method according to claim 32 wherein the overlappable region of the primary overlap component of each virtual key overlaps with at least one neighboring virtual key in the same row.

34. A method according to claim 32 further comprising providing the primary overlap component of each virtual key having a conventional region which is non-overlapping with the conventional region of the primary overlap component of any other virtual key, wherein the activation criterion associated with the conventional region comprises a tap.

35. A method according to claim 32 wherein at least one of the rows of virtual keys each have primary input components with one of two activation criteria, wherein the two activation criteria are assigned to the virtual keys in alternating fashion.

36. A method according to claim 35 wherein the two activation criteria of the virtual keys in the row comprise a down-right swipe and a down-left swipe.

37. A method according to claim 32 wherein a plurality of the virtual keys have a secondary overlap component associated therewith.

38. A method according to claim 37 wherein each secondary overlap component has an overlappable region substantially co-located with the overlappable region of the primary overlap component of the associated virtual key.

39. A method according to claim 37 wherein at least one of the rows of visual keys each have secondary input components with one of two activation criteria, wherein the two activation criteria are assigned to the secondary input components in alternating fashion.

40. A method according to claim 39 wherein the two activation criteria of the secondary input components comprise an up-right swipe and an up-left swipe.

41. A method according to claim 1 wherein the graphical user interface comprises a web browser wherein the primary overlap components comprise hyperlinks.

42. A method according to claim 41 wherein the hyperlinks comprises one or more of:
a conventional region with an activation criterion which is a tap;
an overlappable region with an activation criterion which is a directional swipe; and,
an overlappable region with an activation criterion which is a tap combined with a button pressed.

43. A method according to claim 42 comprising providing the overlappable region with an activation criterion of a directional swipe is substantially coextensive with the overlappable region with an activation criterion of a tap combined with a button pressed.

44. A method according to claim 1 wherein the pointing device comprises a mouse, trackball, joystick, touch-pad, stylus, pen, finger or remote controller.

45. A method according to claim 1 wherein:
the computing device comprises a touch screen;
providing the graphical user interface comprises displaying the graphical user interface on the touch screen; and,
receiving the input signals comprises detecting a point of contact on the touch screen.

46. A method according to claim 23 wherein providing the virtual keyboard comprises providing a plurality of secondary virtual keys comprising a plurality of secondary overlap components each having an overlappable region and an overlappable activation criterion associated therewith;
the method further comprising activating a secondary overlap component of a secondary virtual key having an overlappable region which contains the operation location and having the associated overlappable activation criterion which matches the operation behavior.
